(19) United States
(12) Patent Application Publication
(10) Pub. No.: US 2016/0210692 A1
(43) Pub. Date: Jul. 21, 2016

(54) DATA STOCKS INTEGRATED IT MULTI-PLATFORM SYSTEM

(71) Applicant: Alejandro Evaisto Perez, Dallas, TX (US)

(72) Inventor: Alejandro Evaisto Perez, Dallas, TX (US)

(73) Assignee: Alejandro Evaritso Perez, Dallas, TX (US)

(21) Appl. No.: 14/599,533

(22) Filed: Jan. 18, 2015

(51) Int. Cl. G06Q 40/04; G06Q 30/04

(52) U.S. Cl. CPC G06Q 40/04; G06Q 30/04

(57) ABSTRACT

The purpose of this integrated system is to create and sustain Data Stock Markets 42 and a “Business Periscope” 46 that interacts with those markets. The Data Stock Markets 42 unite data renters (henceforth, addressed as demand clients) and sellers of data (henceforth, addressed as supply clients); pay supply clients for their collected Data Stock/s 43, while protecting and hiding their identity and sensitive personal information by refining and producing Aggregate Categorical Data Blocks 44. The “Business Periscope” 46 allows demand clients to easily produce Business “Deals” 26, which grant access to Data Stock/s 43, Aggregate Categorical Data Blocks 44, Data Compositions 47, and/or other data sources in order to quickly produce and mobilize upon business insights that yield business value, such as increasing revenues, finding cost savings, building new markets, improving product deployments, develop new services, and/or other value added activities.

### BACKGROUND OF INVENTION

The purpose of this integrated system is to create and sustain Data Stock Markets 42 and a “Business Periscope” 46 that interacts with those markets. The Data Stock Markets 42 unite data renters (henceforth, addressed as demand clients) and sellers of data (henceforth, addressed as supply clients); pay supply clients for their collected Data Stock/s 43 to collect, while protecting and hiding their identity and sensitive personal information by refining and producing Aggregate Categorical Data Blocks 44. The “Business Periscope” 46 allows demand clients to easily produce Business “Deals” 26, which grant access to Data Stock/s 43, Aggregate Categorical Data Blocks 44, Data Compositions 47, and/or other data sources in order to quickly produce and mobilize upon business insights that yield business value by increasing revenues, finding cost savings, building new markets, improving product deployments, develop new services, and/or other value added activities.

### DESCRIPTION OF THE RELATED ART

Patent application 20030154171 is a system for selling personal information through a trusted third party. The assignee is Hewlett Packard Company (henceforth addressed as HP). HP focuses on selling personal information. The “Data Stocks Integrated IT Multi-Platform System” (henceforth addressed as “The Data Stocks System”) does the polar opposite, since most people (in our case, supply clients) do not want to sell nor transfer their personal information to 3rd parties. This is due to the fear of misuse, corporate misbehavior, and identity theft, which is not uncommon. In contrast to HP, “The Data Stocks System” collects personal data from the supply clients with a promise and focus on removing, anonymizing, massing, protecting, and/or encrypting the supply clients' personal sensitive information in order create aggregate categorical data blocks for rental with a minimum 10,000 population sample size, which produces a “Needle-in-hey-Stack” effect. While HP sells and transfers individual personal information to 3rd parties, “The Data Stocks System” allows demand clients to rent these anonymized Aggregate Categorical Data Blocks 44. By renting, the demand clients are allow to view, mix, and/or act upon the Aggregate Categorical Data Blocks 44, but the demand clients will never possess the data nor be allowed the download the data from the system into their private networks. The data will stay in the “The Data Stocks System” in order improve security and reduce the possibility of demand clients' misuse, misbehavior, and identity theft. Even data that the demand clients provide from the private networks, once uploaded into the “The Data Stocks System”, will not be allow to be downloaded. Very simple, once data is in the “The Data Stocks System”, supply clients and demand clients cannot download it.

### BRIEF SUMMARY OF INVENTION

A unified system of multiple information technology platforms for performing data consent management, data collecting, data storage, data processing, data refining, data delivery, data blocking, data trading, data renting, data mixing, data visualization, action-ability, and/or data team collaboration in order to create and sustain “Data Stock Markets” 42 and the Crystalis “Business Periscope” platform 46 with the objectives of uniting demand client/s and supply client/s reach price equilibrium for the supply client/s's data and “Data Rights” 50 in order to produce rental monetary compensation, while protecting the supply clients' sensitive personal information via Aggregate Categorical Data Blocks 44 creation; and demand clients can create and convert the Data Compositions 47 into business insights into actionable opportunities using the “Business Periscope” in order to improve their commercial success.

### CLASSIFICATION

Since this is “Data Stocks System” can be an integrated system with several platforms, mechanisms, features, and/or monetization strategies, the below Cooperative Classifications help label the mentioned items.

Cooperative Classification: G06Q 30/0201/G06Q 30/0202/G06Q 30/0204/G06Q 30/0205/G06Q 30/0206/G06Q 30/0208/G06Q 30/0222/G06Q 30/0224/G06Q 30/0228/G06Q 30/0242/G06Q 30/0246/G06Q 30/0255/G06Q 30/0267/G06Q 30/0283/G06Q 30/0605/G06Q 30/0613/G06Q 30/0615/G06Q 30/0617/G06Q 30/0619/G06Q 30/0621/G06Q 30/0623/G06Q 30/0633/G06Q 30/0645/G06Q 20/00/G06Q 20/02/G06F 15/16/G06Q 10/0637/G06Q 10/0631/G06Q 30/0253

### DETAILED DESCRIPTION OF THE INVENTION

The “Data Stocks System” can be experienced by supply client/s and demand client/s from different angles. Therefore, a Supply Client User Perspective and Demand Client User Perspective are required to fully understand the mechanics and the specifications as showed in FIG. 1.

Invention from Supply Client User Perspective: The Supply Client User enters a Data Stocks Mobile Application (one variant of the Data Stocks Trading Application/s 48) via his/her mobile smart phone (Computer/s & Device/s 1). The Supply Client User must perform Authentication Methods 53 (FIG. 5d) to enter the Data Stocks Main Page (FIG. 5a). The Data Stocks System validates the Supply Client User's profile and grants access via the Policy Engine Platform 18 and Security Platform 20, which are on server/s 5. Once in the main screen Data Stocks Mobile Application, the Supply Client User is now interacting with the Data Trading Platform 13 (FIG. 3). On main screen, the Supply Client User views the “Data Markets” Dashboard Feature 27, notes that his/her income potential is at 72%, and thus not fully maximized. The Supply Client User decides to understand why his/her income potential is not 100% and therefore presses the “Data Markets” Dashboard Feature 27 in order to understand the interference of profit potentials. The Supply Client User notes that the some of the Business “Deals” 26 are turned “Off” 32 (FIG. 5c). One of the Business “Deals” 26 is new and the other is a Business “Deals” 26 that the Supply Client User does not feel like participating. In addition, some Business “Deals” 26 criteria is not fully met as showed by color scheme of the “Quick Criteria” Feature 31 (FIG. 5c). The Supply Client User is enticed by the profit potential displayed by the “Total Ask” Feature 33 and decides to makes some changes. As a result, the Supply Client User enters into the desired Business “Deals” 26 using the “Enter & Exit Business Deals” Feature 32 and reviews the criteria of all the Business “Deals” 26 in order see what he/she requires to fully qualify. The Supply Client User is now interacting with the Data Consent Management Platform 6 via the Data Trading Platform 13. The Supply Client User notices that the criteria are not met due to a combination of price mismatching and turned “Off” 34 Data Stocks 43. Based on the color scheme, the Supply Client User drills down by pressing into the discrepancies, which transfer him/her to the “My Data Stocks” Feature 28 (FIG. 5b) via basic hyperlinks. There, the Supply Client User is able to see what Data Stocks 43 are turn “Off”. By using the “On and Off” Consent Management Feature 34, the Supply Client User turns “On” all the Data Stocks that the Business “Deals” 26 criteria asked for. Normally, the Supply Client User turns likes to review the Dynamic Pricing 25 of what the Data Stock Markets 42 are trading at for his/her Data Stocks 43. However, the Supply Client User is in a hurry due to personal business. Therefore, in order speed the process, the Supply Client User decides to use the “Auto-Adjust” Feature 24, instead of the “Name Your Price” Feature 23 (FIG. 3).

As the Supply Client User is performing these interactions in the Data Trading Platform 13, the Data Consent Management Platform 6 is updating the Policy Engine Platform 18. Then, the Policy Engine Platform 18 informs the Data Collection Platform 7 and the Data Blocking Platform 12 to begin using the Data Source Extracting/Retrieval Techniques 38 and Data Blocking Techniques 39 (FIG. 7). The Data Collection Platform 7 executes the Data Source Extracting/Retrieval Techniques 38 and imports the results into the Data Storage Platform 8 after receiving entrance approval from the Security Platform 20. The collected Data Stocks 43 enter the Data Storage Platform 8. Once in the Data Storage Platform 8, the Policy Engine Platform 18 directs the Data Refining Platform 10 to begin using multiple techniques and transformation to convert the Supply Client User's Data Stocks 43 to become part of Aggregate Categorical Data Blocks 44 (FIG. 2b). Once the Data Stocks 43 become part of Aggregate Categorical Data Blocks 44, the Data Refining Platform 10 and the Data Storage Platform 8 inform the Policy Engine Platform 18 of the completion. The Policy Engine Platform 18 informs the Data Trading Platform 13 and Data Renting Platform 15. As a result, the Data Trading Platform 13 updates the Business “Deals” 26 that supply client/s view and the Data Stock Markets 42's Dynamic Pricing 25 adjust accordingly. In the meantime, Data Renting Platform 15 updates the Business “Deals” 26 for the demand client/s to stay informed of the progress (FIG. 2c).

Once the totality of Business “Deals” 26 is criteria is fully met from the population sample, the Data Renting Platform 15 informs the Policy Engine Platform 18 to begin coordinating with the Billing/Payment Platform 17 and the Data Trading Platform 13. While Data Trading Platform 13 updates and clears the Business “Deals” 26, the Billing/Payment Platform 17 arranges monetary transactions between the supply clients and the demand client/s (FIG. 2a).

The original Supply Client User receives a notification from the Policy Engine Platform 18, which he/she selected in his/her “My Account” Feature 30, that the Billing/Payment Platform 17 has arranged the monetary compensation. The Supply Client User view the Money “Transfer” Feature 29 in order to see his/her monetary gains. Using the Money “Transfer” Feature 29, the Supply Client User orders the Billing/Payment Platform 17 to receive payment to their personal bank account.

As the Supply Client User enjoys his/her monetary compensation, Consent Management Platform 6 continues to inform the Policy Engine Platform 18 to coordinate the Data Collection Platform 7 and the Data Blocking Platform 12 to maintain using the Data Source Extracting/Retrieval Techniques 38 and Data Blocking Techniques 39 on all “On” 34 Data Stocks 43 in order to ready the Supply Client User for future Business “Deals” 26, and, thus, repeat the satisfying experience.

Invention from Demand Client User Perspective: The Demand Client User enters opens his browser 2 in order to begin accessing his/her Crystalis “Business Periscope” Instance 45. As the Demand Client User request for access, the Security Platform 22 performs “Authentication Methods” 53 in order to ensure the validity of the Demand Client User. The Demand Client User's business entity decided to license with the patent owning entity a total of 3 Business Intelligence Applications 60, which (for this scenario) are IBM Cognos, Tableau, and Good Data; therefore, the Policy Engine Platform 18 informs the Data Analytics/Business Intelligence Platform 16 performs the licensing and begin installation (if not already pre-loaded in a session for readiness) (FIG. 2a).

Once validated, the Crystalis “Business Periscope” Platform/s 46 creates the Demand Client User's Crystalis “Business Periscope” Instance's 45 and informs the Policy Engine Platform 18 to enforce its policies in order to the Business Intelligence Applications 60, settings, and profile, while the Remote Access Platform 21 produces a remote access session for the Demand Client User (FIG. 8). The Demand Client User enters the customized Crystalis “Business Periscope” Instance 45 and decides to use the Tableau BI software (FIG. 10).

Once in the Tableau BI software session, the Demand Client User request to import the data into the session in order to begin viewing the Aggregate Categorical Data Blocks 44, Data Compositions 47, and/or other data sources that the Demand Client User's business entity currently owns. The import request triggers the Data Delivery Platform 11, which triggers the Policy Engine Platform 18 to review the access to these data libraries. Permission is granted and the Demand Client User decides to select and load a “Dallas Customers Sample: Geolocation and their Music” Hortonworks Hadoop Hive file.

With the selection, the Data Manipulation Multi-Platform 54 processes the request and the Data Delivery Platform 11 transfer the file into the Tableau Software (FIG. 2b). The Demand Client User interacts with the file in Tableau and notices several unique patterns, and he/she is curious if these business insights affects all of Texas's major cities. Particularly Austin, San Antonio, and Houston. Demand Client User reviews the file library and notices that several major cities in Texas are not on hand. To the Demand Client User, that means that he/she needs to rent the new information in order to provide a good conclusion for his/her supervisors.

Demand Client User minimizes Tableau and opens the Data Stocks Rental & Trader Application 58, which interact with the Data Trading Platform 13 and the Data Rental Platform 15 (FIG. 10). The Policy Engine Platform 18 reviews the access policies and access is granted. There, Demand Client User views the Data Stock Markets 43 and the Data Stocks 43 that he/she will require to build on the business insights. After careful review, Demand Client User produces the Business “Deals” 26 and criteria required to rent the needed data. Demand Client User requests a unique set of Google Maps, Apple Maps, iTunes, Pandora, GrooveShark, and other Data Stocks 43.

The Business “Deals” 26 are loaded into the Data Trading Platform 13 and the Data Stocks Trading Application/s 48 begin displaying Business “Deals” 26 to the supply clients. With a notification setting turned “On”, the supply clients quickly notice the Demand Client User's Business “Deals” 26. Over the next 3 days, 500,000 of supply clients decide to join the Business “Deals” 26 by turning “On” 32 the Business “Deals” 26 and meeting the criteria in the Data Stocks Trading Application/s 48. As the 500,000 of supply clients join, the Data Renting Platform informs and notifies the Demand Client User of the progress.

Once ready, the Demand Client User executes rent of the Business “Deals” 26, but he/she is denied due to the Policy Engine Platform 18. Demand Client User forgot that he/she needs higher authority to perform such a large multi-million dollar transaction. Using the Collaboration Platform 52, the Demand Client User invites his/her supervisors to view and approve the Business “Deals” 26. The supervisors agreed and perform the rental for the Business “Deals” 26. Once executed, the Data Rental Platform and the Policy Engine Platform coordinate with the other platform.

Since the Business “Deals” 26 has been agreed and the criteria is fully met from the population sample, the Data Renting Platform 15 informs the Policy Engine Platform 18 to begin coordinating with the Billing/Payment Platform 17 and the Data Trading Platform 13. While Data Trading Platform 13 updates and clears the Business “Deals” 26, the Billing/Payment Platform 17 arranges monetary transactions between the supply clients and the Demand Client User's business entity.

As the process is happening, Data Manipulation Multi-Platform begins 54 turning the Data Stocks 43 into Aggregate Categorical Data Blocks 44 and keeping the Demand Client User of the progress. The good news was that 60% of the data was already in the system, so collecting and importing the other 40% from the Data Collecting Platform 7 took only 24 hours. Within 2 days, the Business “Deals” 26 complete and the Aggregate Categorical Data Blocks 44 are now inside file/s that are ready to be used, which are placed in the Demand Client User's library in the Data Delivery Platform 11 (FIG. 2b).

Demand Client User now uses the Data Block Mixer Application 57 (FIG. 10), which supported by the Data Mixing Platform 14, to combine the previous file and the new file in order to create a new consolidate file, which can be called a Data Composition 47. This new file is used imported into the Tableau BI session. There, the Demand Client User is now able to see full picture of the business insights.

With this new business insights, Demand Client User decides that some of the opportunities need to be acted upon. Using the Action-Ability Application 59, Demand Client User and his/her team begins coordinating business resources by mobilizing highway advertising signs requests, new store locations requests, location store music change requests, music artist sponsorship deal requests, and/or other business request actions.

Demand Client User's supervisors are so impressed with the business insights that they believe it can be profitable to other industries and partnering allies. Since they are separate entities, the Demand Client User is asked to lease the mentioned Data Composition 47 in the Secondary Data Market Activities 49 for other demand client/s to rent. Using the Data Stocks Trader & Renter Application 58, the Demand Client User creates a Business “Deals” 26 for the Secondary Data Market Activities 49, which will show in the Data Stocks Trader and Rental application for selected demand client/s, instead of the Data Stocks Trading Application/s 48 for supply client/s. Regardless if only viewable in the Data Stocks Trader & Renter Application 58, the Data Trading Platform 13 and the Policy Engine Platform price, monitor, and control its transaction for other demand client/s.

After a few days, four unique demand clients that are also in Crystalis “Business Periscope” Instance/s 45 rent the Data Composition 47 from the Demand Client User's business entity. The same processes and mechanisms allow the Demand Client User's business entity to profit from the original Business “Deals” 26 and re-profit from the leasing of the new Data Composition 47's Business “Deals” 26 in the Secondary Data Market Activities 49. The Demand Client User's supervisors are pleased and continue to allow their authorized Demand Users to use the Data Stocks System to transform their business enterprise.

### SPECIFICATIONS

1. Computer/s & Device/s: an electronic device/s for storing and processing data, typically in binary form, according to instructions given to it in a variable program. Examples: personal computers, PC, laptops, netbooks, desktops, terminals, phones, smart phones, gaming platforms, TVs, smart wristbands, etc. . . . The “Data Stocks System” interacts computers and devices for many reasons, such as data extraction 38, data blocking 39, installing the Data Stocks Trading application/s 48, accessing to the “Data Stocks System” 48, etc. . . .
2. Browser Applications: A web application, web app, web-based application is any software that runs in a web-browser. It is created in a browser-supported programming language (such as the combination of JavaScript, HTML and CSS) and relies on a web browser to render the application, such as webmail, online retail sales, online actions, wikis, etc. . . . The “Data Stocks System” interacts computers and devices for many reasons, such as data extraction 38, data blocking 39, installing the Data Stocks Trading application/s 48, accessing to the “Data Stocks System 48, etc. . . .
3. Desktop Applications: An application/s that runs stand alone in a desktop or laptop computer. Contrast with “Web-based application,” which requires the Web browser to run. The “Data Stocks System” interacts computers and devices for many reasons, such as data extraction 38, data blocking 39, installing the Data Stocks Trading application/s 48, accessing to the “Data Stocks System 48, etc. . . .
4. Mobile Applications: A mobile application/s is a computer program designed to run on smartphones, tablet computers and other mobile devices. Although the system will extract data from data devices, CLAIM 3 expands on the use of the Data Stocks Mobile Application. The “Data Stocks System” interacts computers and devices for many reasons, such as data extraction 38, data blocking 39, installing the Data Stocks Trading application/s 48, accessing to the “Data Stocks System 48, etc. . . .
5. Server/s: a computer or computer program that manages access to a centralized resource or service in a network. Central, and usually the largest, and most powerful computer in a network that houses the server software, stores and manages common (network) data and supplies it to the individual workstations (clients), and provides shared services. There are several types of server types such as proxy servers, FTP servers, collaboration servers, server appliance, SIP proxy servers, email servers, application proxy servers, virtual servers, remote access servers, etc. . . . The “Data Stocks System” will use a combination of servers, virtualize servers, and/or server clusters to create and sustain the Data Consent Management Platform 6, Data Collection Platform 7, Data Storage Platform 8, Data Processing Platform 9, Data Refining Platform 10, Data Delivery Platform 11, Data Blocking Platform 12, Data Trading Platform 13, Data Mixing Platform 14, Data Renting Platform 15, Data Analytics/Business Intelligence Platform 16, Billing/Payment Platform 17, Policy Engine Platform 18, Big Data Platform 19, Security Platform 20, Action-Ability Platform 21, and the Remote Access Platform 21. Therefore, it applies to all claims that have any the mentioned platforms.
6. Data Consent Management Platform: An IT platform of servers dedicated to ensure that supply clients and demand clients can manage their consent over Data Stocks 43, Data Compositions 47, and/or other data sources, and/or Business “Deals” 26 within the system. User interphase and application/s can be in the Data Stock Trading Application/s 4 in order to utilize features such as “On and Off” Consent Management Feature 34, “Enter & Exit Business Deals” Feature 32, and/or others features. Decision and actions can affect the Policy Engine Platform 18.
7. Data Collection Platform: An IT platform of servers dedicated to ensure that collection of data is successfully imported into the system inside the Data Storage Platform 8. It uses Data Source Extracting/Retrieval Techniques 38, which can be affect the Policy Engine Platform 18.
8. Data Storage Platform: An IT platform of servers dedicated to data storage that records, stores, retrieves, and reads information (data) from any medium, including the medium itself, using memory, components, devices and media that retain digital computer data used for computing for some interval of time. Normal features include fault tolerance, high performance, non-blocking, databases, silicon based switched architecture designed to provide the bandwidth needed to support infrastructure consolidation of enterprise file and block-based storage services on and behind a single platform. File formats will vary depending on demand client/s needs. This platform can be enhanced and interacts by the Big Data Platform 19, Data Refining Platform 10, Data Processing Platform 9, Data Delivery Platform 11, and/or Policy Engine Platform 18.
9. Data Processing Platform: An IT platform of servers dedicated to processing the selection of Aggregate Categorical Data Blocks 44. This platform can interact with the Data Storage Platform 8, Big Data Platform 19, Data Refining Platform 10, Data Delivery Platform 11, Data Renting Platform 15, and/or Policy Engine Platform 18.
10. Data Refining Platform: An IT platform of servers dedicated to refining data using multiple techniques and transformations to add value and security to the data in order to produce Aggregate Categorical Data Blocks 44. This platform can interact with the Data Storage Platform 8, Big Data Platform 19, Data Processing Platform 9, Data Mixing Platform 14, Data Delivery Platform 11, and/or Policy Engine Platform 18.
11. Data Delivery Platform: An IT platform of servers dedicated to expediting the delivery of Aggregate Categorical Data Blocks 44 and the file/script libraries for demand client/s to access. This platform can interact with the Data Storage Platform 8, Big Data Platform 19, Data Processing Platform 9, Data Refining Platform 10, Data Mixing Platform 14, Data Renting Platform 15, and/or Policy Engine Platform 18.
12. Data Blocking Platform: An IT platform of servers dedicated to blocking data leaks both internally within the system and externally to the system with Data Blocking Techniques 39, in order to ensure legal compliance, and protect the value and integrity of the Aggregate Categorical Data Blocks 44, pre-Aggregate Categorical Data Blocks 44, Data Compositions 47, and other data; and thus the improve the profitability of supply clients. This platform can interact with the Data Storage Platform 8, and/or Policy Engine Platform 18.
13. Data Trading Platform: An IT platform of servers dedicated to serving the creating and sustainment of the Data Stock Markets 42, where supply clients and demand clients can reach price equilibrium for the data rentals of Business “Deals” 26 via Dynamic Pricing 25. This platform can also perform Secondary Market Activities 49 by re-selling/re-renting Business “Deals” 26 and Data Compositions 47. This platform can interact with the Data Renting Platform 15, Data Consent Management Platform 6, Billing/Payment Platform 17, and/or Policy Engine Platform 18. User interphases and applications can be in the Data Stocks Trading Application/s 48 and the Crystalis “Business Periscope” Instance 45.
14. Data Mixing Platform: An IT platform of servers dedicated to the ability to mix and blend Aggregate Categorical Data Blocks 44, demand client internal data, and/or other data sources in order to create Data Compositions 47 that can create synergic business insights, which separate sources of data cannot produce as stand-alone data. This platform can interact with the Data Renting Platform 15, Data Delivery Platform 11, Data Processing Platform 9, and/or Policy Engine Platform 18. The Data Block Mixer Application 57 can be one of the user interphases that can be used in the Crystalis “Business Periscope” Instance 45.
15. Data Renting Platform: An IT platform of servers dedicated to renting Aggregate Categorical Data Blocks 44 within the Data Trading Platform 13, and the management and production of Business “Deals” 26. This platform can interact with the Data Trading Platform 13, Data Mixing Platform 14, Data Delivery Platform 11, Data Processing Platform 9, and/or Policy Engine Platform 18. User interphase and application/s can be in the Crystalis “Business Periscope” Instance 45.
16. Data Analytics/Business Intelligence Platform: An IT platform of servers dedicated to managing licensing, and selecting and loading (or preloading) Business Intelligence Applications 60 into the Crystalis “Business Periscope” Instance 45. With these Business Intelligence Applications 60, user/s can select and visualizing the Aggregate Categorical Data Blocks 44, demand client internal data, external data, and/or Data Compositions 47, in order to produce valuable business insights for commercial success. This platform can interact with the Data Mixing Platform 14, Data Delivery Platform 11, Data Processing Platform 9, and/or Policy Engine Platform 18. User interphase and application/s can be in the Crystalis “Business Periscope” Instance 45.
17. Billing/Payment Platform: An IT platform of servers dedicated to ensure the monetary transactions and brokering performed in the Data Trading Platform 13 and Data Renting Platform 15. User interphases and applications are in the Data Stocks Trading Application/s 48 and the Crystalis “Business Periscope” Instance 45. In addition, several of the services, clearing activities, and/or applications can be outsourced to 3rd parties that specialize in these activities.
18. Policy Engine Platform: An IT platform of servers dedicated to monitoring, controlling, and/or executing the policies, settings, and/or profiles of the patent owning entity, the demand clients, and/or the supply clients. This platform can consist of the Supply Policy Engines Platform 36 and the Demand Policy Engines Platform 37. This platform can interact with the Big Data Platform 19, Data Refining Platform 10, Data Processing Platform 9, Data Delivery Platform 11, Data Mixing Platform 14, Data Consent Management Platform 6, Data Collection Platform 7, Data Storage Platform 8, Data Blocking Platform 12, Data Trading Platform 12, Data Renting Platform 15, and/or any of the components in the Crystalis “Business Periscope” Platform 46 and the Data Stocks Trading Application/s 48. These platform can include secondary Policy Engine Platform 18 to ensure redundancy and avoid system failures.
19. Big Data Platform: An IT plat form of servers dedicated to enhancing that the Data Storage Platform 8, Data Refining Platform 10, Data Processing Platform 9, and the Data Delivery Platform 11 in order sustain performance during interactions of massing data levels of Terabytes and higher via the latest “Big Data” technologies.
20. Security Platform: An IT platform of servers, network devices, and other hardware, such as firewalls, dedicated to ensure the security transactions (such as HTTPS, VPN, SSL, tokens, etc. . . . ), authentication methods (passwords, biometrics, etc. . . . ) 53, and control the threats (malicious code, viruses, Trojans, worms, macros, hackers, etc. . . . ) to the system from internal and external of sources in order to avoid them, stop them, counter them, isolate them, and/or monitor them. This platform is distributed through the system.
21. Action-Ability Platform: An IT platform of servers dedicated to facilitating and mobilizing business resources in order to improve the execution of business insights and opportunities found using the Data Analytics/Business Intelligence Platform 16. User interphase and application/s can be in the Crystalis “Business Periscope” Instance 45.
22. Remote Access Platform: An IT platform of servers dedicated to remote access of demand clients' access into the system, mainly the Crystalis “Business Periscope” Platform 46, in order to increase security and sustain the short distances between platforms, which improves performance and reduces network bandwidth.
23. “Name Your Price” Feature: Feature that allows supply clients set the strike price for their Data Stock/s 43 in the Data Trading Platform 13 to settle and participate in the Data Stock Markets 42 and Business “Deal” 26.
24. “Auto-Adjust” Feature: Feature that allows supply clients to auto-set the strike price for their Data Stock/s 43 in the Data Trading Platform 13 to automatically settle and automatically participate in the Data Stock Markets 42 and Business “Deal” 26, while reducing interaction and improve money making opportunities.
25. Dynamic Pricing: Feature found in any modern stock market where buyers and sellers perform bid and ask prices for stocks in order to reach price equilibrium between supply and demand economic forces. In this case, this feature can apply to Data Stock/s 43 and/or Data Stock Markets 42.
26. Business “Deals”: The grouping of Aggregate Categorical Data Blocks 44, future grouping of Aggregate Categorical Data Blocks (Data Stock/s 43 yet to be processed by the system), Data Compositions 47, and other sources of data that demand client/s are asking for from a particular supply client population sample size in order to rent in exchange for a monetary compensation. A Business “Deal” can be sponsored by one or several demand client/s. The criteria can consist of demand client/s's qualifications for supply clients, selection of qualified supply clients, match data pricing based on Dynamic Pricing 25, and other minor features to ensure transactions in order to create and sustain of active Data Stock Markets 42. Business “Deal” can be re-traded/re-rented/lease to other demand client/s in Data Trading Platform 13 via Secondary Market Activities 49. Additional nomenclatures for Business “Deals” can include: “Deal”, “Data Deal”, “Data Bundle”, “Bundle”, “Bundles”, “Categories”, “Data Block Deal”, “Data Compositions Deals”, etc. . . .
27. “Data Markets” Dashboard Feature: Feature can allow supply client/s to view, monitor, control, and/or drill down in the summary of all future monetary gains from all (26) business “Deals” the supply client is currently participating, which is based on Dynamic Pricing 25, and their percentage of how many Business “Deals” 26 they are currently all the criteria for. This feature can be found in the user interphases and/or applications of the Data Stocks Trading Application/s 48 and in the Crystalis “Business Periscope” Instance 45 for Secondary Data Market Activities 49.
28. “My Data Stocks” Feature: This feature can allow supply client/s to view, monitor, control, and drill down to all the Data Stock/s 43 that are currently “On” (“On and Off” Consent MGMT Button) 34 and aligned with all turned “On” Business “Deals” 26 (Color: green), all turned “Off” (Color: gray) 34, and/or needed to be turned “On” to reach 100% on all “On” Business “Deals” 26 to maximize their rental monetary compensations (Color: Red). This feature can be found in the user interphases and/or applications of the Data Stocks Trading Application/s 48.
29. Money “Transfer” Feature: This feature can allow supply client/s to view, monitor, control, and/or drill down to all transfer actualized monetary gains to the supply clients gained from renting their Data Stock/s 43 from the Business “Deals” 26 they participated in, and which the transaction/s have concluded. This monetary gains distributions are performed by the Billing/Payment Platform 17. The Billing/Payment Platform 17 also performs the billing to the demand clients that they offered for those (26) Business “Deals”. This feature can be found in the user interphases and/or applications of the Data Stocks Trading Application/s 48 and in the Crystalis “Business Periscope” Instance 45 for Secondary Data Market Activities 49.
30. “My Account” Feature: This feature can allow supply client/s to view, monitor, control, and/or drill down on their individual user profiles, settings, and preferences to enhance their experiences within the system.
31. “Quick Criteria” Feature: This feature can allow supply client/s to quickly view all the Data Stock/s 43 that are currently “On” (via the “On and Off” Consent MGMT Feature 34) and aligned with all “On” (via the “Enter & Exit Business Deals” Feature 32) Business “Deals” 26 (Color: green), “Off” 32 Business “Deals” 26 and thus not required Data Stock/s 43 (Color: gray), and/or Data Stock/s 43 needed to be turned “On” 34 in order meet the criteria of “On” 32 Business “Deals” 26 to maximize their monetary gains (Color: Red).
32. “Enter & Exit Business Deals” Feature: This feature can allow supply client/s to enter and exit Business “Deals” 26 with the “On and Off” button. See CLAIM 4. This feature can be found in the user interphases and/or applications of the Data Stocks Trading Application/s 48 and in the Crystalis “Business Periscope” Instance 45 for Secondary Data Market Activities 49.
33. “Total Ask” Feature: This feature can allow demand clients to show a total compensation for their Business “Deals” 26 based on the accumulated Dynamic Pricing of the Data Stock/s 43 in order to entice supply clients that entered that Business “Deals” 26. This feature can be found in the user interphases and/or applications of the Data Stocks Trading Application/s 48 and in the Crystalis “Business Periscope” Instance 45 for Secondary Data Market Activities 49. See CLAIM 4.
34. “On and Off” Consent Management Feature: This feature can allow supply client/s to grant and/or deny access to their Data Stock/s 43, Aggregate Categorical Data Blocks 44, Data Compositions 47, and other sources, which they selected, for their brokering, storage, and/or trading. This feature can be found in the user interphases and/or applications of the Data Stocks Trading Application/s 48 and in the Crystalis “Business Periscope” Instance 45 for Secondary Data Market Activities 49. This feature interacts with the Data Consent Management Platform 6 and the Policy Engine Platform 18.
35. “Market Flux Reader” Feature: This feature can allow supply client/s to view changes in its respective data markets relative to the dynamic price in the “Name Your Price” Feature 23 box. “Green Arrows” signify data market is pay more premium than the current set price in the “Name Your Price” Feature 23 box. “Red Arrows” signify data market is pay is below than the current Dynamic Price 25 in the “Name Your Price” Feature 23 box and thus unlikely to qualify for the criteria of many of Business “Deals” 26. This feature can be found in the user interphases and/or applications of the Data Stocks Trading Application/s 48 and in the Crystalis “Business Periscope” Instance 45 for Secondary Data Market Activities 49.
36. Supply Policy Engines Platform: Major component of the Policy Engine Platform 18 that contains several types and numbers of policy engines for supply client/s and the patent owning entity's policy engine (henceforth addressed as “Corporate Policy Engines”). This component can include the “Supply Client Policy & Settings” Policy Engine, which deals with any supply client/s's profiles and settings at the user level to execute and validate the consent management platform's features and mechanisms. This includes supply clients' profiles and settings at the user level that import their Data Stock/s 43 into the system. “Supply Client Policy Engine” deals with any demand clients profiles importing data policies, abilities, restrictions at their enterprise level to its enterprise users, to be execute and be validate the consent management platform's features and mechanisms. This mechanism also functions for Secondary Data Market Activities 49, which is when the demand client/s can become supply client/s for other demand client/s. The Corporate Policy Engine can validates and ensure that patent owning entity's policies and regulations can monitor, control, and/or supersede any conflicting policies toward the other supply policy engines.
37. Demand Policy Engines Platform: Major component of the Policy Engine Platform 18 that contains several types and number of policy engines for the demand clients with the addition of the Corporate Policy Engines. This component can include the “Demand Client Profile & Settings” policy engines managed any demand client's profiles and settings at the user level in order populate the Crystalis “Business Periscope” Instance 45 for demand client's user experience, such as types of software business intelligences software, preferences, and recently used files. “Demand Client Policy Engines” focus on enterprise demand client's policies to access, extract, mix, trade, rent, produce Business “Deals” 26, validate, Secondary Data Market Activities 49, deny and/or any other functions and/or restrictions dictated by the enterprise unto its users. The Corporate Policy Engine can validates and ensure that patent owning entity's policies and regulations can monitor, control, and/or supersede any conflicting policies toward the other demand policy engines.
38. Data Source Extracting/Retrieval Techniques: The features in the Data Collection Platform 7 that can execute the retrieval of any Data Stock/s, demand client internal information, and/or other sources authorized by the Policy Engine Platform 18. The results are sent to the Data Storage Platform 8. There are several known techniques, such as SOAP APIs, REST APIs, scripting, Cookies 51, basic uploading, and other common techniques. Other unique techniques can include dual transactions. This data retrieval technique will signal the authorized device and/or authorized client's data source to send 2 transactions: one to the destination sources and another to this system. While APIs focus on retrieving data from the destination source, dual transactions focus on retrieving data from the original point of data origin. This will be required from data sources that refuse to provide APIs, deny access, and/or other peaceful means to acquire data that was granted and agreed-on within the Policy Engine Platform 18 between the patent owning entity, the demand clients, and the supply clients.
39. Data Blocking Techniques: The features in the Data Blocking Platform 12 that can execute the stoppage of any unauthorized transactions and distributions not granted Policy Engine Platform 18. This can be internal within the system in order to stop any data leaks with the system or external from the system in order to stop unauthorized 3rd parties. Blockage Techniques include denial of service requests, automatic information “opt-out” requests on behalf of clients to 3rd parties, removal of spybots from devices, etc. . . .
40. “Front End” (FE) Interface: Front end interface are applications that focus on the frontal interaction with user and the back end interface. This represents the interface and controls that the user will select, click, type-on, and/or pressing using a mouse and/or finger. This feature can be represented by user interphases and/or applications in the Data Stocks Trading Application/s 48 and in the Crystalis “Business Periscope” Instance 45.
41. “Back End” (BE) Interface: Back End platforms, such as the servers 5, the Data Collection Platform 7, the Big Data Storage 19, etc. . . . , that the client user/s will not normally interact with and/or simply be denied to access to in order for that platform to stay secured and functional. This platforms will be mainly accessible to the patent owning entity and/or authorized parties.
42. Data Stock Markets: The market/s of Data Stock/s 43, Aggregate Categorical Data Blocks 44, Data Compositions 47, and/or other data sources that are created and sustain in the Data Trading Platform 13. Using Dynamic Pricing 25, these markets set the value of the Business “Deals” 26. This can include objects of the Secondary Data Market Activities 49. Additional nomenclatures can include “Data Markets”, “Data Market”, “Data Stocks Market”, “Data Stock Exchange”, “Data Leasing Markets”, etc. . . .
43. Data Stock/s: A single data source, multiple sources of data, and/or “Data Rights” 50 that demand client/s would find of ethical business value and that supply client/s owns, has, and/or produces. This can include demographic data, mobile application/s data and their activity, desktop application/s data and their activity, public information, medical information, credit information, browser history, browser data and their activity, records, music, social media, gaming sessions, online transactions, etc. . . . These Data Stock/s can be collected by Data Collection Platform 7, stored in the Data Storage Platform 8, and converted into Aggregate Categorical Data Blocks 44 by the Data Processing Platform 9 and the Data Refining Platform 10, in order to protect supply client/s's private, secret, and/or personal information. Data Stock/s are traded in the Data Stock Markets 42 using Dynamic Pricing 25 by the Data Trading Platform 13 in order to determine the rental value in the Data Renting Platform 15.
44. Aggregate Categorical Data Blocks: Blocks of Data Stock/s 43 that have been enhanced by the Data Processing Platform 9 and the Data Refining Platform 10 in order to in order to protect supply client/s's private, secret, sensitive, and/or personal information. They can be mixed and blended into Data Compositions 47 with the methods utilized by the Data Mixing Platform 14. These data blocks are requested by Business “Deals” 26 in order to be rented in the Data Renting Platform 15. The value of these data blocks can be determined by the Data Stock Markets 42 in the Data Trading Platform 13. These data block can be part of the Secondary Data Market Activities 49. The file formatting will depend on the demand client/s' needs and by requirements of the Crystalis “Business Periscope” Instance/s 45.
45. Crystalis “Business Periscope” Instance/s: A remote desktop instance/s produced in Crystalis “Business Periscope” Platform/s 46, where a demand client user/s can view, mix, rent, produce Business “Deals” 26, trade, and/or act upon the Data Compositions 47, Aggregate Categorical Data Blocks 44, and/or sources of data. The instance/s have several pre-loaded applications for business intelligence & analytics, data trading, data renting, data mixing, Business “Deals” 26 creation, perform Secondary Data Market Activities 49, action-ability, and/or other support element that can be configured by the Policy Engines Platform 37. This instances can be accessed remotely via the Remote Access Platform 22 and collaborated upon as a demand client/s team/s 52. In addition, when Crystalis “Business Periscope” Platform/s 46 are disconnected from the Data Stock Markets 42, Crystalis “Business Periscope” Instance/s can be used in the demand client/s's premise and/or private network.
46. Crystalis “Business Periscope” Platform/s: This integrated platform that can create Crystalis “Business Periscope” Instance/s 45 and can be configured by the Policy Engines Platform 18. The platform can be created and sustained by a combinations of platforms, such as the Data Mixing Platform 14, Data Trading Platform 13, Data Renting Platform 5, Data Analytics/Business Intelligence Platform 16, Policy Engine Platform 18, Remote Access Platform 22, and/or Action-Ability Platform 21. In addition, Crystalis “Business Periscope” Platform/s can be disconnect from the Data Stock Markets 42 in order to be used by demand client/s's premise and/or private network
47. Data Compositions: A combination of data from multiple sources that can include Aggregate Categorical Data Blocks 44, demand client internal data, and/or other sources that can be mixed and blended in the Data Mixing Platform 14 in order to create greater synergistic value for business insights. The file formatting will depend on the demand client/s' needs and by requirements of the Crystalis “Business Periscope” Instance/s 45. These data compositions can be leased in the Secondary Data Market Activities 49.
48. Data Stocks Trading Application/s: The applications and/or interphases that the supply client/s can be use to manage their Data Stocks 43, interact with Data Stock Markets 42, manage Business “Deals” 26, and/or other features required for the supply client/s to safely participate in Data Stock Markets 42 and Business “Deals” 26. This can take the form of Browser Application/s 2, Desktop Application/s 3, Mobile Application/s 4, Cookies 51, and/or website portal/s. This can accessed using Computer/s & Device/s 1. In addition, these applications can include many features (Ex: 23, 24, 25, 27, 28, 29, 30, 31, 32, 33, 34, 35) and/or advertising and/or sponsorship messages in order to raise revenue for the patent owning entity.
49. Secondary Data Market Activities: Feature of the in the Data Trading Platform 13 that allows demand client/s that have rented Aggregate Categorical Data Blocks 44, transacted Business “Deals” 26, and/or created Data Compositions 47 to re-rent and/or lease these mentioned data to other demand client/s for monetary compensation. The feature can be monitored and controlled by the Policy Engine Platform 18 to ensure continuation of protection, protection, and value. This feature allows 3rd parties entities to make money of demand client/s, and/or for demand client/s to recover some of the costs and/or profit from the initial purchases. Thus, demand client/s can become supply client/s in this market. See CLAIM 2.
50. “Data Rights”: The legal right to collect and/or block data from the supply client/s and/or demand client/s. They can be used to authorize Data Source Extracting/Retrieval Techniques 38, managed by the Data Stocks Trading Application/s 48, and/or controlled by the Policy Engine Platform 18 via the Data Consent Platform 6.
51. Cookies: A cookie is a text file that a web server stores in Computer/s & Device/s 1 in order to track transactions, retrieve data, block data, store data, and and/or other activities. They can be used in the Data Source Extracting/Retrieval Techniques 38, installed by the Data Stocks Trading Application/s 48, and/or controlled by the Policy Engine Platform 18.
52. Collaboration Platform: An IT platform of servers dedicated to facilitating demand client/s teams to work together in Crystalis “Business Periscope” Instance/s in order to improve produce business insights and enable the coordination of business resources toward the opportunities found. The Policy Engine Platform 18 can be used to monitor and control these interactions.
53. “Authentication Methods” Features: The features in the Security Platform 20 that can ensure that the user/s accessing the system are reviewed, validated, and/or stopped by using one or multiple method/s, such as passwords, user IDs, biometrics, “Active Directories”, “Single Sign-On”, “Log In With ______” (Google, Facebook, Twitter, etc. . . . ) modules, and/or modern authentication methods. This feature can interact with the Policy Engine Platform 18.
54. Data Manipulation Multi-Platform: A logical grouping of platforms that can consist of the Data Storage Platform 8, Data Processing Platform 9, Data Refining Platform 10, Big Data Platform 19, Policy Engine Platform 18, Data Delivery Platform 11, and/or Data Mixing Platform 14 for the purpose of supporting the Supply Multi-Platform 55 and/or the Demand Multi-Platform 56. Data Manipulation Multi-Platform 54 split into separate grouping to increase security via the Security Platform 20.
55. Supply Multi-Platform: A logical grouping of platforms that can consist of the Data Collection Platform 7, Data Blocking Platform 12, Billing/Payment Platform 17, Data Trading Platform 13, Policy Engine Platform 18, Data Renting Platform 15, and/or Data Consent Management Platform 6 for the purpose of supporting supply client/s, the Data Stock Markets 43, and the Demand Multi-Platform 56. This Multi-Platform can be split into separate grouping to increase security via the Security Platform 20.
56. Demand Multi-Platform: A logical grouping of platforms that can consist of the Data Mixing Platform 14, Data Trading Platform 13, Data Renting Platform 15, Data Analytics/Business Intelligence Platform 16, Policy Engine Platform 18, Remote Access Platform 22, Action-Ability Platform 21 and/or Collaboration Platform 52 for the purpose of supporting the Supply Multi-Platform 55 and the Crystalis “Business Periscope” Platform/s 46. Demand Multi-Platform split into separate grouping to increase security via the Security Platform 20.
57. Data Block Mixer Application/s: Software application/s that can allow demand client/s to perform many functions, which can include mixing and editing Aggregate Categorical Data Blocks 44, internal demand client data, and/or Data Compositions 47 that are rented in the Data Stocks Trader & Renter Application 58 into newer Data Compositions 47. The user interphase can be in the Crystalis “Business Periscope” Instance/s 45. This application is supported by the Data Mixing Platform 14 and can include the ability to upload demand client/s's internal information into the Aggregate Categorical Data Blocks 44 and/or Data Compositions 47.
58. Data Stocks Trader & Renter Application/s: Software application/s that can allow demand client/s to perform many functions, which can include the reviewing Data Stock Markets' 42 dynamic pricing 25; renting Aggregate Categorical Data Blocks 44; production and monitoring of Business “Deal” 26 that are rented in the Data Stocks Trading Application/s 48; production and monitoring of Business “Deal” 26 that are rented for the Secondary Data Market Activities 49. This user interphase can be in the Crystalis “Business Periscope” Instance/s 45. This application is supported by the Data Mixing Platform 14 and/or can include many of the features from the Data Stocks Trading Application/s 48.
59. Action-Ability Module: Software application/s that can allow demand client/s to perform many functions, which can include the mobilization of resources, request to mobilize resources, strategic resource management, and/or compare standard versus actual results of those mobilized resources. This user interphase can be in the Crystalis “Business Periscope” Instance/s 45. This application is supported by the Data Mixing Platform 14 and can include the ability to upload user/client information to the data blocks.
60. Business Intelligence Application/s: Software application/s that can allow demand client/s to perform many functions, which can be to retrieve, analyze, transform and/or report data for business intelligence. The tools generally read data that have been previously stored, often, though not necessarily, in a data lakes, data warehouses, data marts, and/or, in our case, the Data Storage Platform 8. This user interphase can be in the Crystalis “Business Periscope” Instance/s 45. This application is supported by the Data Analytics/Business Intelligence Platform 16, Data Delivery Platform 11, and/or other platforms. Examples of these applications and modules can be IBM Cognos, Tableau, Good Data, etc. . . .

### DESCRIPTION OF DRAWINGS & TABLES

TABLE 1 is a table of the combination of the system, its various platforms, and mechanisms from the minimal viable system to the full Data Stocks Integrated Multi-Platform Systems.

FIG. 1 is a schematic diagram of the system, its various platforms, and mechanisms.

FIG. 2a is a schematic diagram snapshot of the Supply Multi-Platform 55, its various platforms, and mechanisms and its respective specifications.

FIG. 2b is a schematic diagram snapshot of the Data Manipulation Multi-Platform 54, its various platforms, and mechanisms and its respective specifications.

FIG. 2c is a schematic diagrams snapshot of the Demand Multi-Platform 56, its various platforms, and mechanisms, and its respective specifications

FIG. 3 is a schematic diagram snapshot of a working prototype of the Trading Platform 13, supporting platforms, its mechanisms, and features.

FIG. 4 is a working prototype diagram snapshot of the Main Navigation Page of the mobile application (Data Stocks Trading Application/s 48) in a browser, its mechanisms, and features.

FIG. 5a is of a working prototype diagram of the mobile application (Data Stocks Trading Application/s 48) regarding multiple Business “Deals” 26, the Data Consent Management Platform 6 interaction, the Data Trading Platform 13, its mechanisms, and features.

FIG. 5b is of working prototype diagrams of the mobile application (Data Stocks Trading Application/s 48) regarding multiple Data Stock/s 43, the Data Consent Management Platform 6 interaction, the Data Trading Platform 13, its mechanisms, and features.

FIG. 5c is of working prototype diagrams of the mobile application (Data Stocks Trading Application/s 48) regarding multiple styles of representing Business “Deals” 26, the Data Consent Management Platform 6 interaction, the Data Trading Platform 13, its mechanisms, and features.

FIG. 5d is of a working prototype diagram of the mobile application (Data Stocks Trading Application/s 48) regarding multiple “Authentication Methods” Features 53, its mechanisms, and features.

FIG. 6 is a schematic diagram snap of the Policy Engines Platform 18, Supply Policy Engine 36, Demand Policy Engine 37, its various associations with other platforms, and mechanisms.

FIG. 7 is a schematic diagram snapshot of the Data Collection Platform 7 & Data Blocking Platform 12, their respective techniques, its various associations with other platforms, and other mechanisms.

FIG. 8 is a schematic diagram snapshot of the Crystalis “Business Periscope” Platform 46, Crystalis “Business Periscope” Instance/s 45, its various applications (such as 57, 58, 59, 60), associations with other platforms, and mechanisms.

FIG. 9 is a schematic diagram snapshot of the multiple platforms split into “Front End” (FE) Interface 40 and “Back End” (BE) Interface 41, its various associations with other platforms, and mechanisms.

FIG. 10 is of a working prototype diagram of the Crystalis “Business Periscope” Instance/s 45, its various applications (such as 2, 57, 58, 59, 60), associations with other platforms, mechanisms, and features.

TABLE 1
DATA STOCKS INTEGRATED IT MULTI-PLATFORM SYSTEM-COMBINATIONS

| | Specification Number | | | | | | | | | | | |
|---|---|---|---|---|---|---|---|---|---|---|---|---|
| | 1 | 2 | 3 | 4 | 5 | 6 | 18 | 7 | 8 | 9 | 10 | 11 |
| | System Segments | | | | | | | | | | | |
| | | | | | | Consent Stack | | Data Manipulation | | | | |
| | HW & Apps | | | | | Data | Policy | Data | Data | Data | Data | Data |
| Component | | Browser | Desktop | Mobile | | Consent | Engine | Collecting | Storage | Process- | Refining | Delivery |
| Combinations | Computer(s) | Appli- | Appli- | Appli- | Ser- | Management | Plat- | Plat- | Plat- | ing Plat- | Plat- | Plat- |
| For System/s | & Device(s) | cation(s) | cation(s) | cation(s) | ver(s) | Platform | form | form | form | form | form | form |
| Minimal Viable | ✓ | ✓ | ✓ | x | ✓ | x | x | ✓ | ✓ | ✓ | ✓ | ✓ |
| System | | | | | | | | | | | | |
| (Business | | | | | | | | | | | | |
| Periscope | | | | | | | | | | | | |
| Platform- | | | | | | | | | | | | |
| On Premise) | | | | | | | | | | | | |
| Minimal | ✓ | ✓ | ✓ | ✓ | ✓ | ✓ | ✓ | ✓ | ✓ | ✓ | ✓ | ✓ |
| Fuctional Data | | | | | | | | | | | | |
| Stocks System | | | | | | | | | | | | |
| (Periscope + | | | | | | | | | | | | |
| Data Stock | | | | | | | | | | | | |
| Markets | | | | | | | | | | | | |
| Capabilities) | | | | | | | | | | | | |
| Full Data | ✓ | ✓ | ✓ | ✓ | ✓ | ✓ | ✓ | ✓ | ✓ | ✓ | ✓ | ✓ |
| Stocks | | | | | | | | | | | | |
| Integrated | | | | | | | | | | | | |
| Multi-Platform | | | | | | | | | | | | |
| System | | | | | | | | | | | | |
| | | Specification Number | | | | | | | | | | |
| | | 12 | 13 | 14 | 15 | 16 | 17 | 20 | 19 | 21 | 22 | 52 |
| | | System Segments | | | | | | | | | | |
| | | Data Manipulation | | | | | Transactional | | Big | Additional | | |
| | | | | | | Analytics/ | Assurance | | Data | Features | | |
| | | Data | Data | Data | Data | Business | Billing/ | | Big | Action- | Remote | Collabor- |
| | Component | Blocking | Trading | Mixing | Renting | Intelligence | Payment | Security | Data | Ability | Access | ation |
| | Combinations | Plat- | Plat- | Plat- | Plat- | Plat- | Plat- | Plat- | Plat- | Plat- | Plat- | Plat- |
| | For System/s | form | form | form | form | form | form | form | form | form | form | form |
| | Minimal Viable | x | x | x | x | ✓ | ✓ | ✓ | x | x | x | x |
| | System | | | | | | | | | | | |
| | (Business | | | | | | | | | | | |
| | Periscope | | | | | | | | | | | |
| | Platform- | | | | | | | | | | | |
| | On Premise) | | | | | | | | | | | |
| | Minimal | x | ✓ | x | ✓ | ✓ | ✓ | ✓ | ✓ | x | ✓ | x |
| | Fuctional Data | | | | | | | | | | | |
| | Stocks System | | | | | | | | | | | |
| | (Periscope + | | | | | | | | | | | |
| | Data Stock | | | | | | | | | | | |
| | Markets | | | | | | | | | | | |
| | Capabilities) | | | | | | | | | | | |
| | Full Data | ✓ | ✓ | ✓ | ✓ | ✓ | ✓ | ✓ | ✓ | ✓ | ✓ | ✓ |
| | Stocks | | | | | | | | | | | |
| | Integrated | | | | | | | | | | | |
| | Multi-Platform | | | | | | | | | | | |
| | System | | | | | | | | | | | |

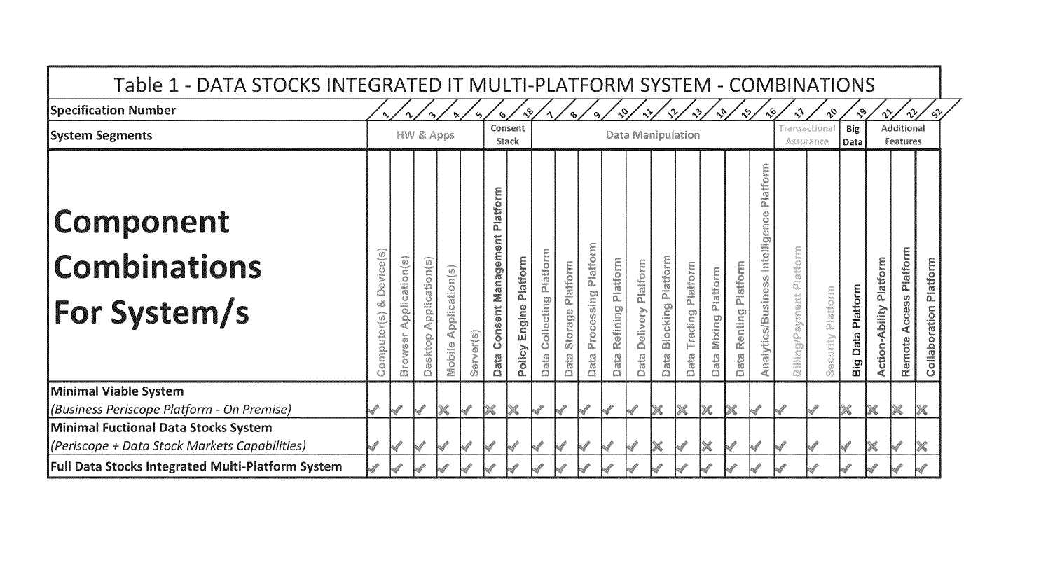

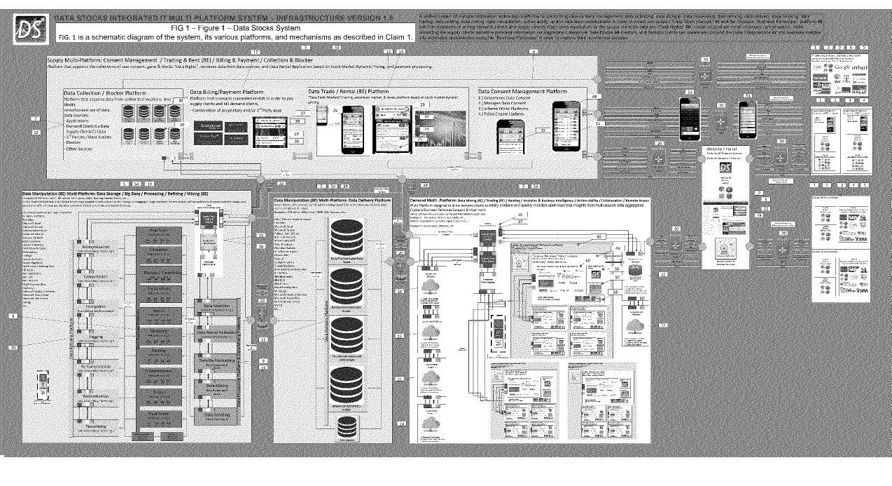

1. An integrated multi-platform system (henceforth addressed as “The Data Stocks System” or system) that can comprise of multiple combinations of at least one computer/device 1, one browser application 2, one desktop application 3, one mobile application 4, one server 5, one data consent management platform 6, one data collecting platform 7, one data storage platform 8, one data processing platform 9, one data refining platform 10, one data delivery platform 11, one data blocking platform 12, one data trading platform 13, one data mixing platform 14, one data renting platform 15, one analytics/business intelligence platform for data visualization 16, one billing/payment platform 17, one policy engine platform 18, one big data platform 19, one security platform 20, one action-ability platform 21, one remote access platform 22, Collaboration Platform 52, and/or additional support elements for the purpose of creating and sustaining Data Stock Markets 42 and/or Crystalis “Business Periscope” Platform/s 46. See Table 1 and FIG. 1 (FIG. 1).

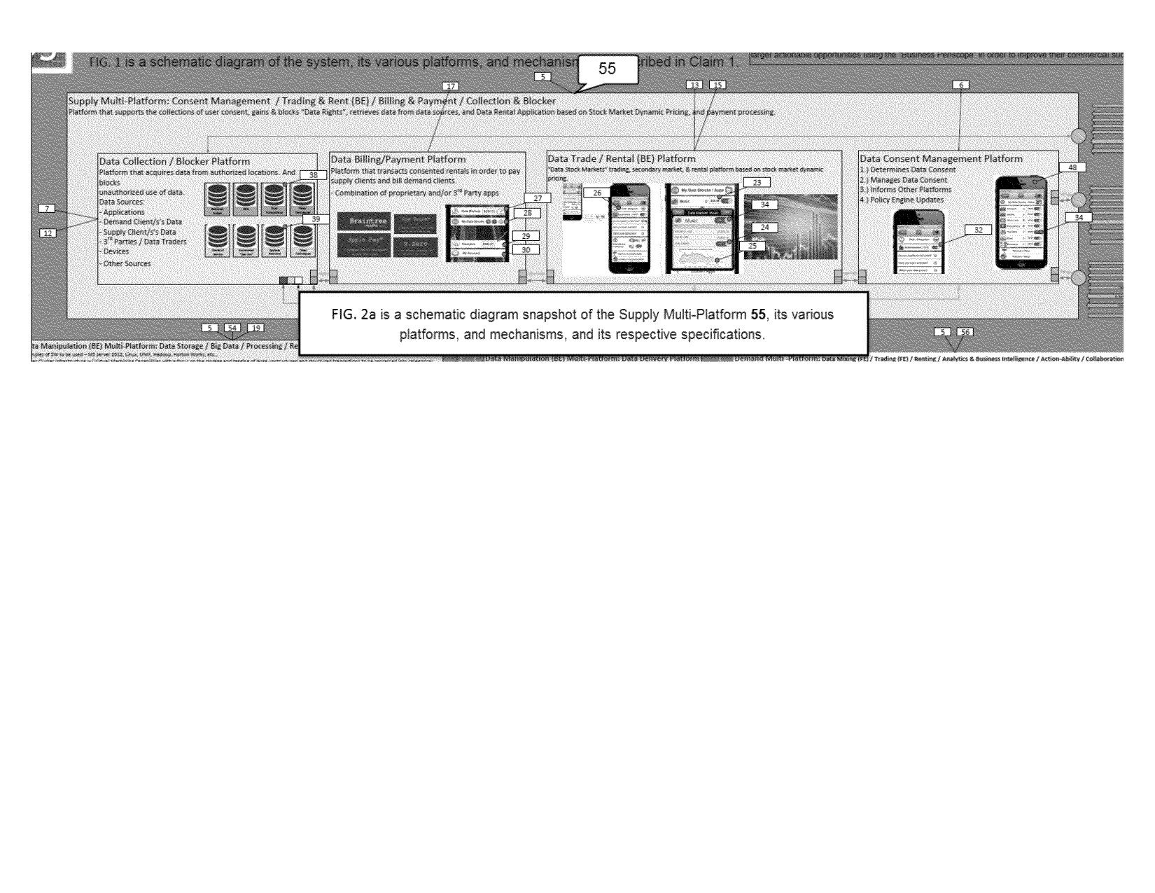

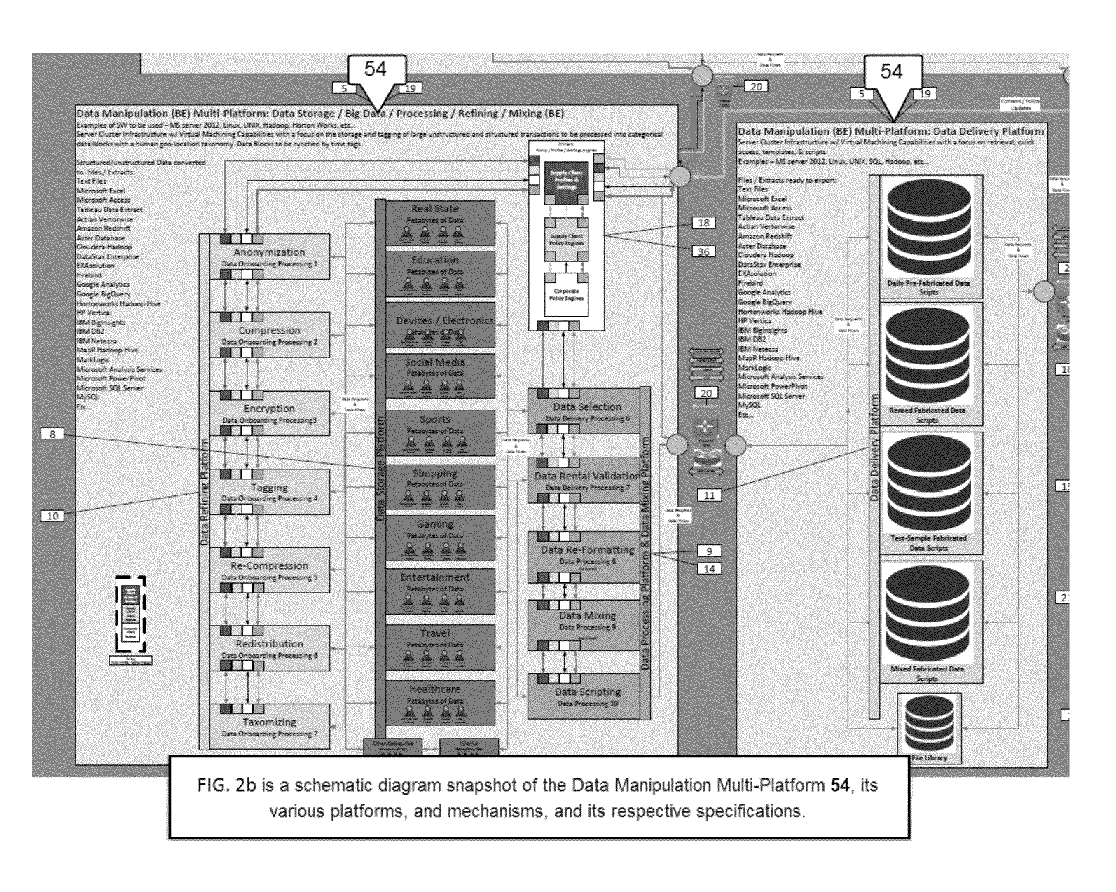

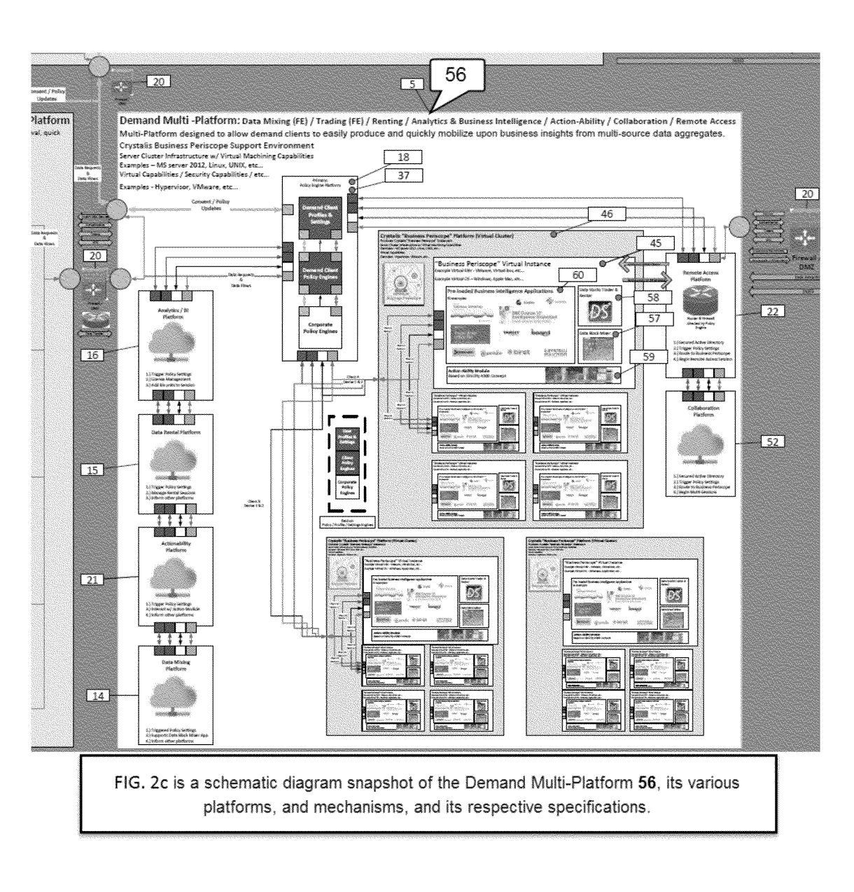

2. The system of claim 1, wherein system can be farther comprised of logical groupings of a combination of platforms such as the Data Manipulation Multi-Platform 54, the Supply Multi-Platform 55, and the Demand Multi-Platform 56 for the several purposes, which can include Increased security and shared server/s 5 resources. Additional subgrouping can be added and removed if needed. See FIG. 2a (FIG. 2a), FIG. 2b (FIG. 2b), and/or FIG. 2c (FIG. 2c).

3. The multi-platforms of claim 2, wherein Supply Multi-Platform 55 can consist of the Data Collection Platform 7, Data Blocking Platform 12, Billing/Payment Platform 17, Data Trading Platform 13, Policy Engine Platform 18. Data Renting Platform 15, and/or Data Consent Management Platform 6 for the purpose of supporting supply client/s, creating and sustaining the Data Stock Markets 43, and interacting with the Demand Multi-Platform 56. See FIG. 2a (FIG. 2a).

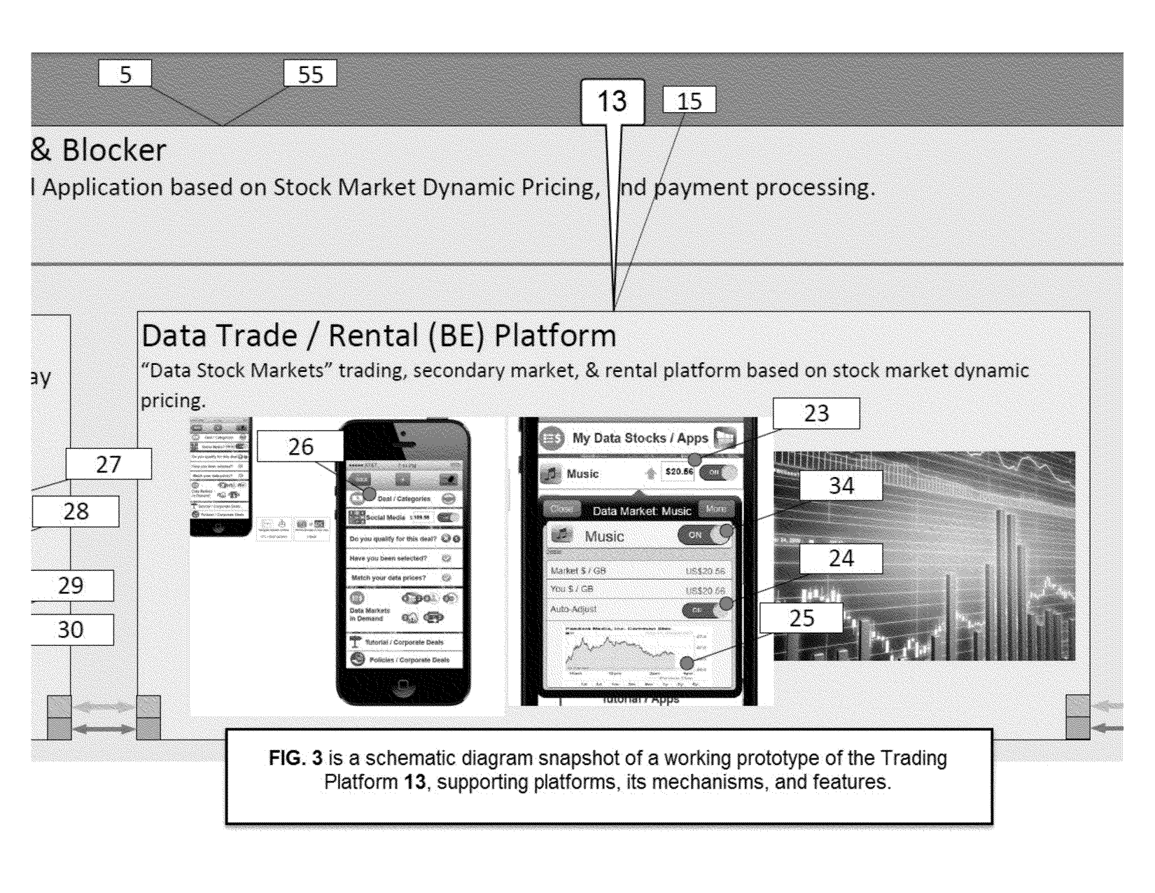

4. The multi-platform of claim 3, further, the Data Trading Platform 13 can consist of server/s 5 and software/s that perform the mechanics of any professional stock market using Dynamic Pricing 25 in order for demand client/s and supply client/s to reach demand and supply price equilibrium in the Data Stock Market/s 42 for Data Stock/s 43 rental transactions of Business “Deals” 26, This claim can include features, such as: “Mama Your Price” Feature 23, “Auto-Adjust” Feature 24, Business “Deals” 26, and other features to create and sustain active Data Stock Market/s 42 and/or active Secondary Data Market Activities 49, See FIG. 3 (FIG. 3).

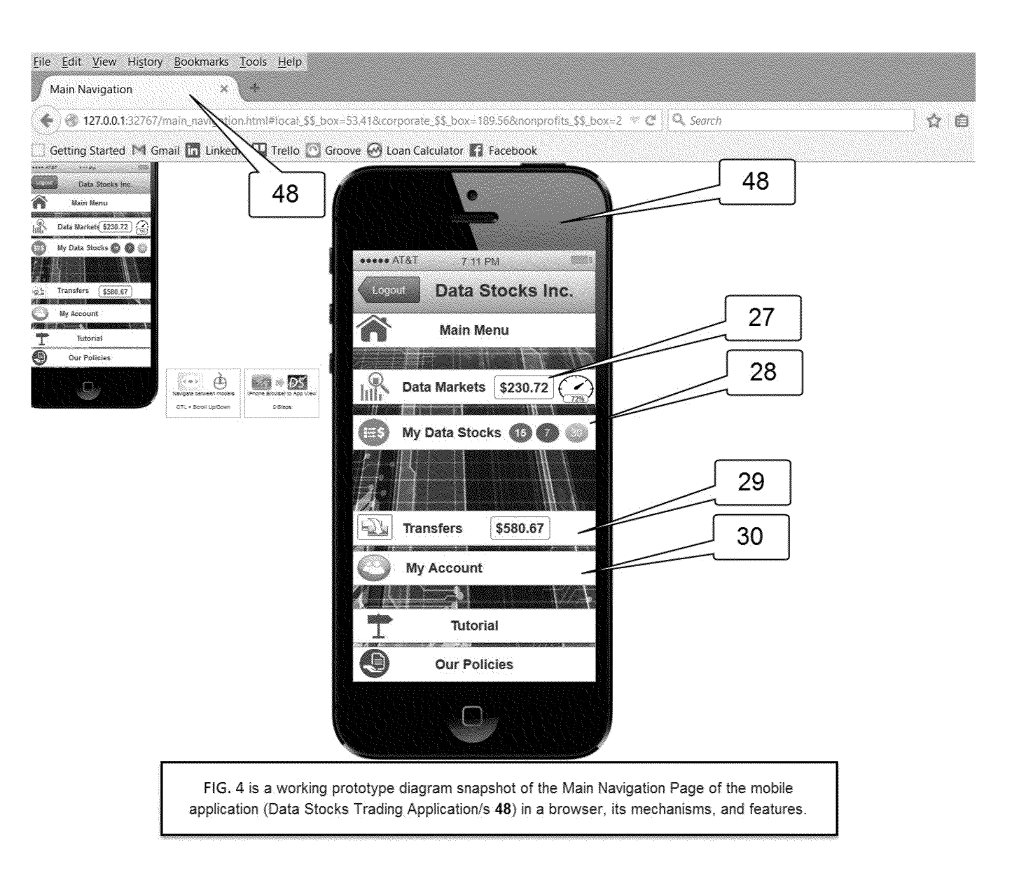

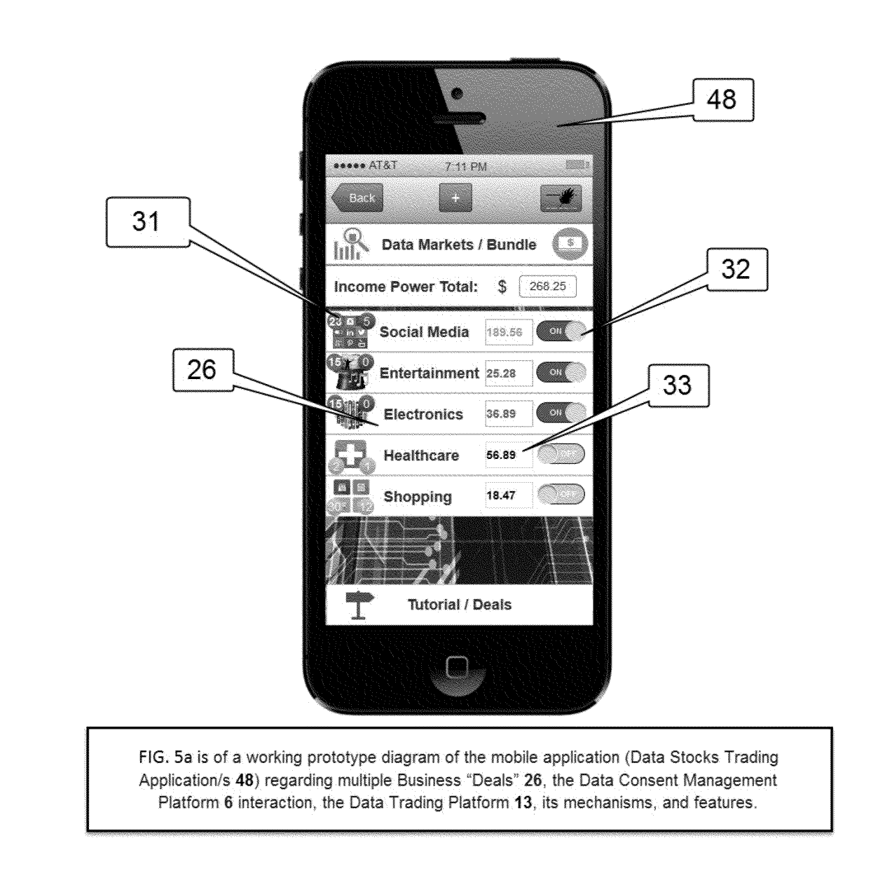

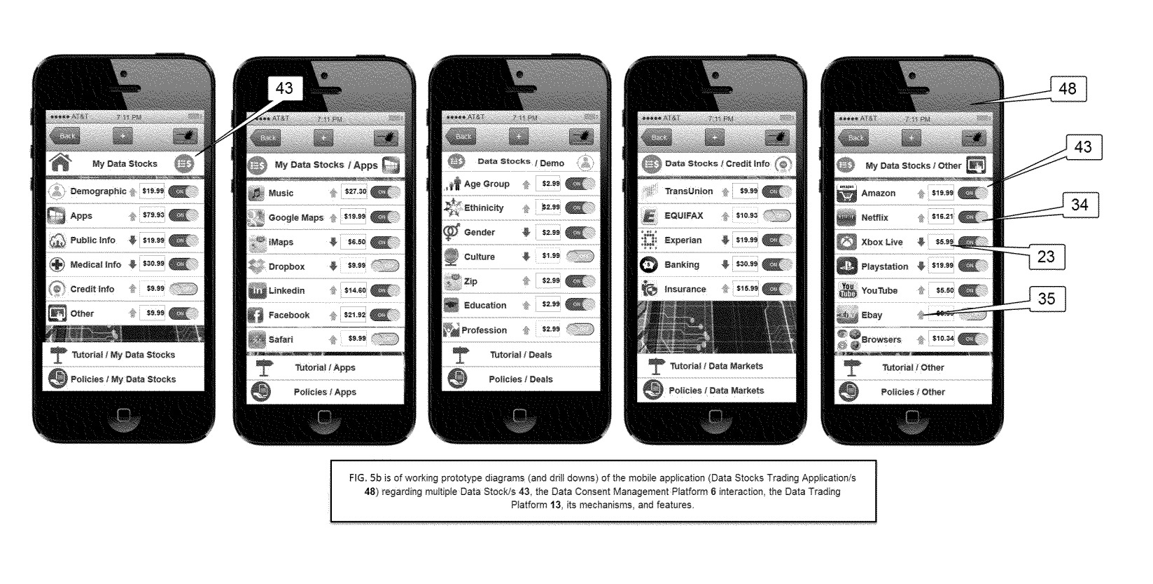

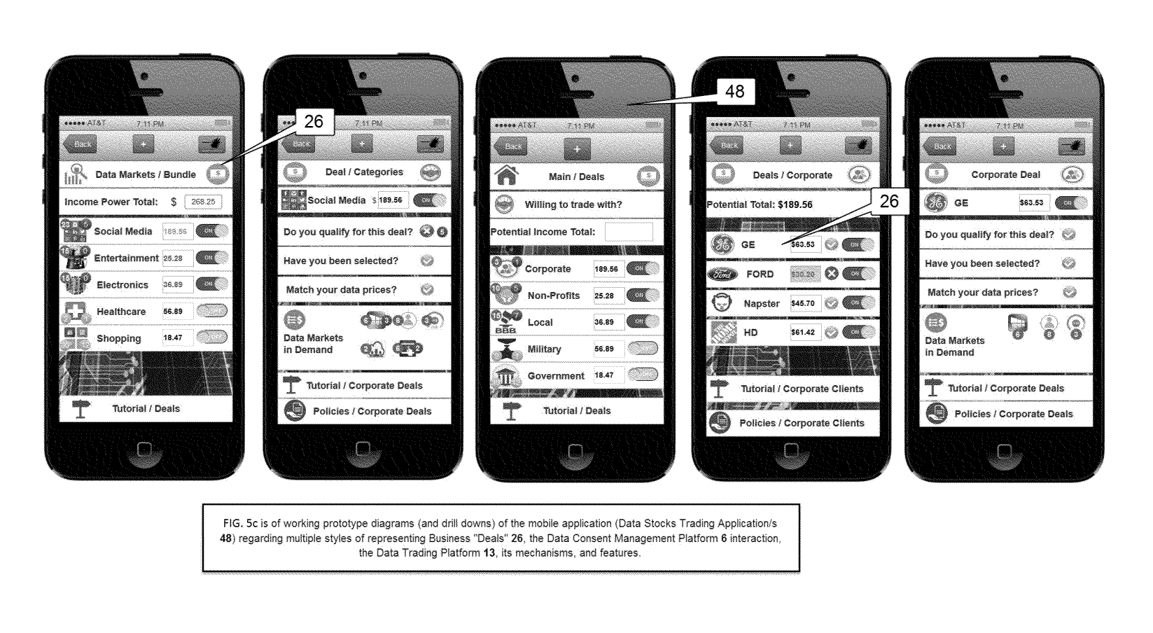

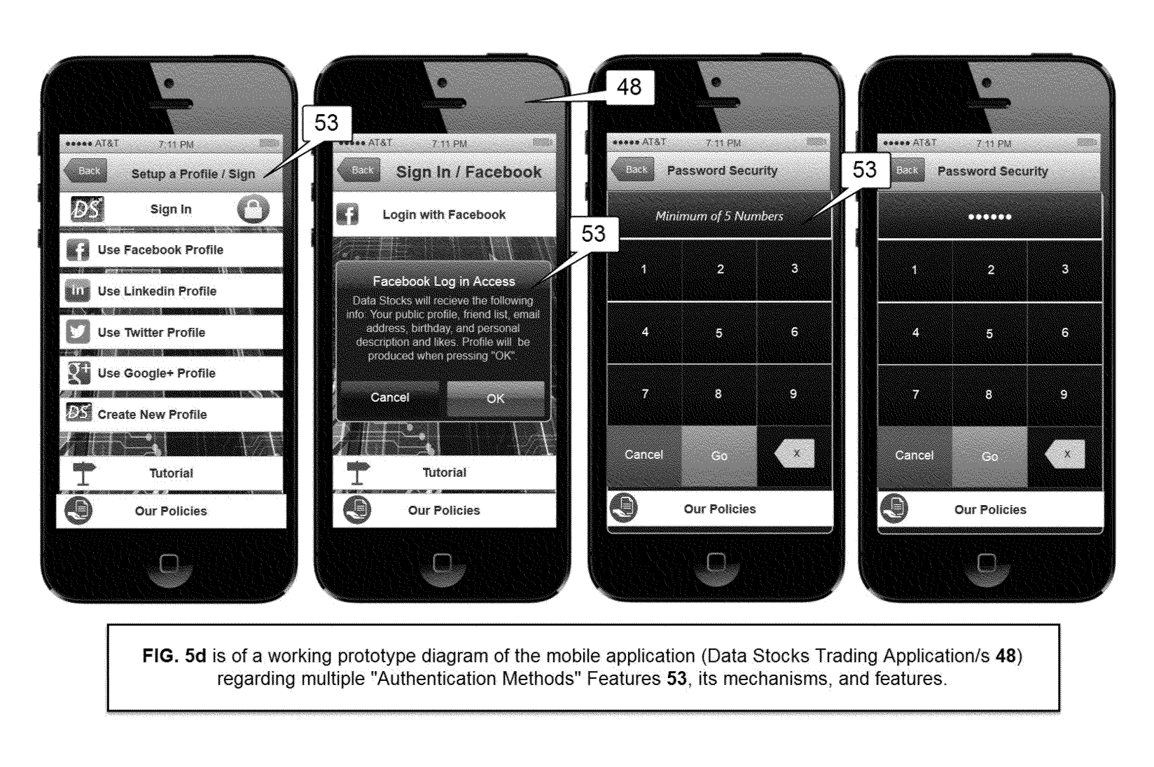

5. The method of claim 4, can further comprise of the Data Stocks Trading Application/s 48 in order to enable supply client/s participation (or exit) 32 in the Data Stock Markets 42 and the Business “Deals” 26; monitor & control data rental transactions of their Data Stock/s 43; perform consent management 34; receive transfer payments 29; account/profile management 30, and/or other minor features that facilitate supply client/s interactions, such as the “Market Flux Reader” Feature 35, “Quick Criteria” Feature 31, “Total Ask” 33 Feature, “Authentication Methods” Features 53, etc. . . . See FIG. 4 (FIG. 4), FIG. 5a (FIG. 5a), FIG. 5b (FIG. 5b), FIG. 5c (FIG. 5c), and/or FIG. 5d (FIG. 5d).

6. The multi-platforms of claim 3, wherein the Data Consent Management Platform 6 can consist of server/s 5 and software/s that create abilities to supply client/s within the Data Stocks Trading Application/s 48 to opt-out, opt-in, informed consent, access, deny, and/or grant the patent owning entity the Data Stock/s 43, Data Compositions 47, and/or other data sources; enter and exit 32 any Business “Deals” 26; and/or, turn “On” or “Off” 34 of selected Data Stock/s 43. With every “On” 34, the Data Blocking Platform 12 can stop any unauthorized use of the supply clients' Data Stock/s 43, Data Compositions 47, and/or other data sources. See FIG. 4 (FIG. 4), FIG. 5a (FIG. 5a), FIG. 5b (FIG. 5b), FIG. 5c (FIG. 5c).

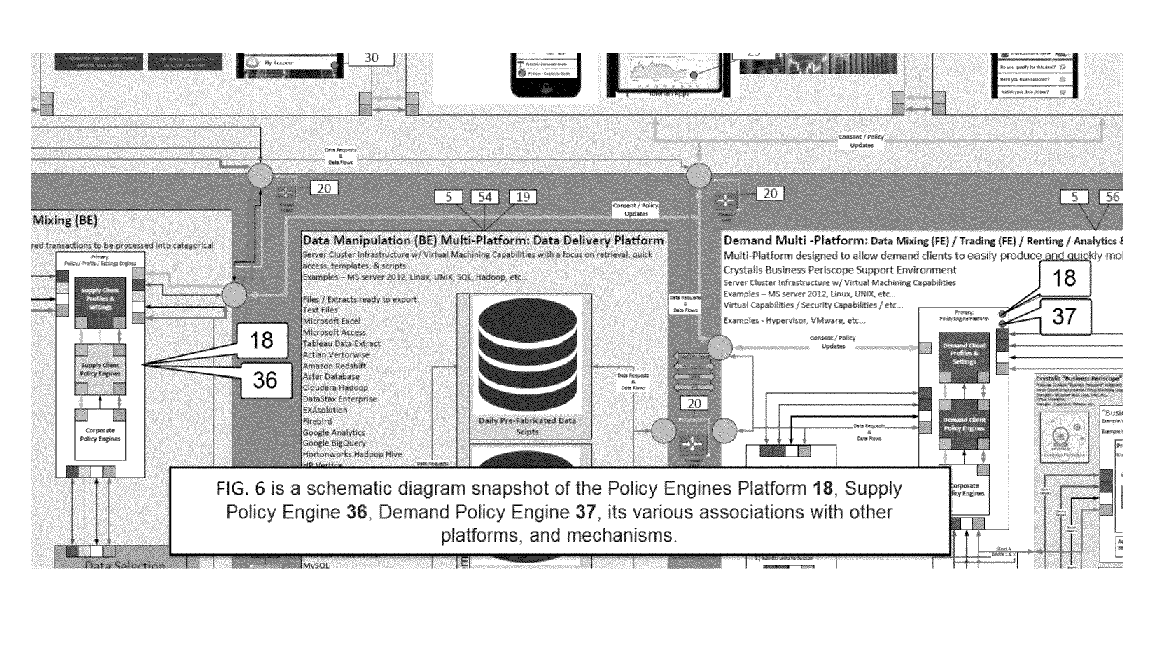

7. The system of claim 1, wherein the Policy Engine Platform 18 can consist of two distinct policy engines platforms 36 & 37, which are server/s 5 and software/s that monitor, control, and/or execute the policies, regulations, settings, and/or profiles of the patent owning entity, the demand client/s, and/or the supply client/s. With these distinct platforms. Policy Engine Platform 18 can interact, enable, and/or disable features, transactions, and/or activities within the Big Data Platform 19, Data Refining Platform 10, Data Processing Platform 9, Data Delivery Platform 11, Data Mixing Platform 14, Data Consent Management Platform 6, Data Collection Platform 1, Data Storage Platform 8, Data Blocking Platform 12, Data Trading Platform 12: Data Renting Platform 15, Collaboration Platform 52, and/or any of the components in the Crystalis “Business Periscope” Platform 46 and/or the Data Stocks Trading Application/s 48. These platform can Include other policy engines and secondary Policy Engine Platform 18 to ensure redundancy, avoid system failures, and improve monitoring and controls for future expansions. See FIG. 6 (FIG. 6).

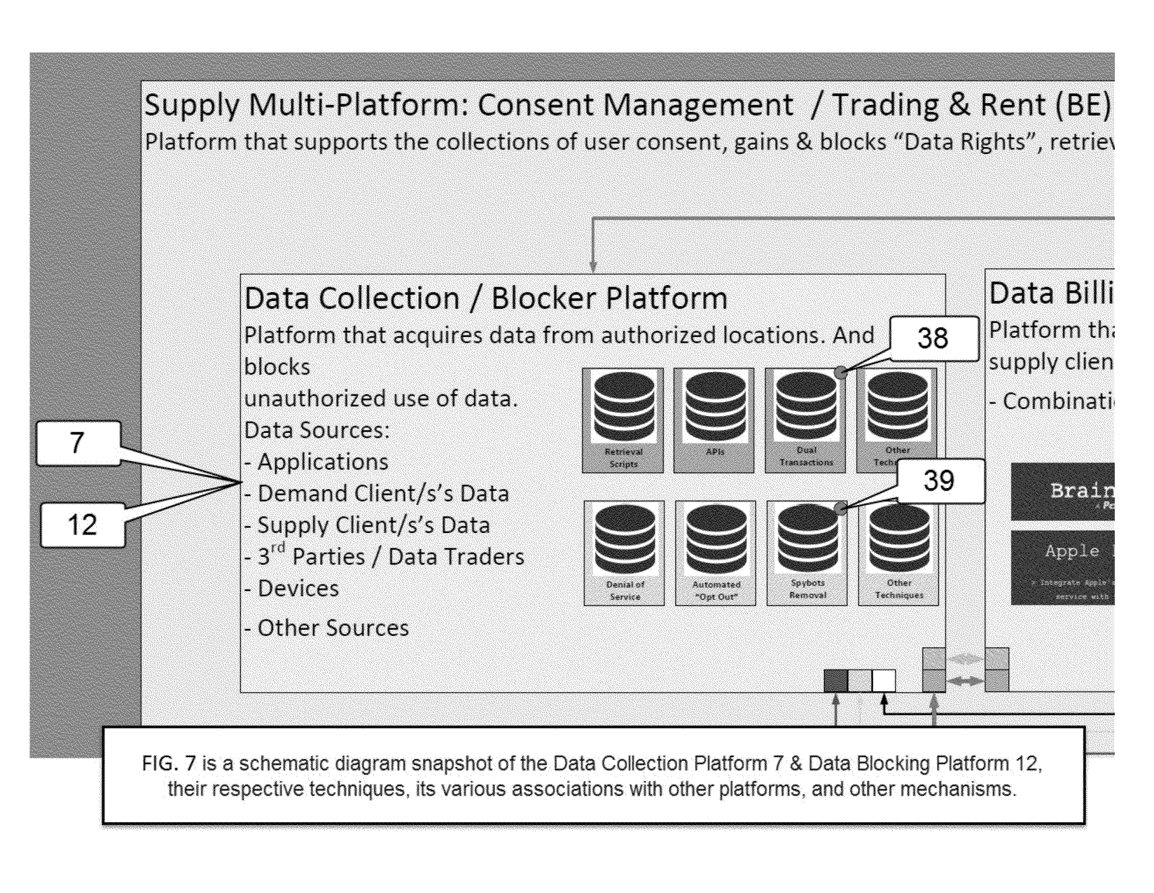

8. The method of claim 1, wherein Data Collection/Blocker Platform can consist of the Data Collection Platform 6 and Data Blocking Platform 12, which are server/s 5 and software/s that can be controlled and monitored by the Policy Engine Platform 18. The Data Collection Platform 6 consists can consist of server/s and software/s that perform Data Source Extracting/Retrieval Techniques 38 in order to extract and import Data Stock/s 43 from Computer/s & Device/s 1, Browser Applications 2, Desktop Applications 3, Mobile Applications 4, Server/s 5, and/or other authorized sources into the Data Storage Platform 8. The Data Blocking Platform 12 can consist of servers and software/s that perform Data Blocking Techniques 39 in order to protect value of the supply clients' Data Stock/s 43. Aggregate Categorical Data Blocks 44, Data Compositions 47, and/or other data sources, and stop any data leaks in Computers & Device/s 1, Browser Application/s 2, Desktop Application/s 3, Mobile Application/s 4, Server/s 5, and/or other unauthorized transactions. See FIG. 7 (FIG. 7).

9. The method of claim 2, wherein Data Manipulation Multi-Platform 54 can consist of the Data Storage Platform 8, Data Processing Platform 9, Data Refining Platform 10, Big Data Platform 19, Policy Engine Platform 18, Data Delivery Platform 11, and/or Data fixing Platform 14 for the purpose of supporting the Supply Multi-Platform 55 and/or the Demand Multi-Platform 56. Data Manipulation Multi-Platform 54 spilt into separate grouping to Increase security via the Security Platform 20. See FIG. 2b (FIG. 2b).

10. The multi-platform of claim 9, wherein the Data Storage Platform 8 can consist of server/s 5 for the purpose receiving inputs, outputs, and other enhancements from the Data Collection Platform 7, Data Processing Platform 9, Data Refining Platform 10, Big Data Platform 19, Policy Engine Platform 18, and/or Data Mixing Platform 14 in order to store Data Stock/s 43, Aggregate Categorical Data Blocks 44. Data Compositions 47, and/or other data sources. See FIG. 2b (FIG. 2b).

11. The multi-platform of claim 9, wherein the Data Refining Platform 10 can consist of server/s 5 and softwares for the purpose of enacting data enhancement techniques to include metadata tagging, anonymization, encryption, taxonomy allocation, categorization, data compression, file formatting, other data treatments in order to transform Data Stocks 43 into Aggregate Categorical Data Blocks 44 and ready them for the Data Processing Platform 9. This platforms can be enhanced by the Big Data Platform 19 and/or the Policy Engine Platform 18. See FIG. 2b (FIG. 2b).

12. The multi-platform of claim 9, wherein the Data Processing Platform 9 can consist of server/s 5 and softwares for the purpose of readying the Aggregate Categorical Data Blocks 44 Data Compositions 47, and/or other data sources for selection, renting validation, mixing 14, re-formatting, scripting, and/or other processing needs in order to provide quick access and delivery by the Data Delivery Platform 11. This platforms can be enhanced by the Big Data Platform 19 and/or the Policy Engine Platform 18. See FIG. 2b (FIG. 2b).

13. The multi-platforms of claim 2, wherein Demand Multi-Platform 56 can consist of the Data Mixing Platform 14, Data Trading Platform 13, Data Ranting Platform 15, Data Analytics/Business Intelligence Platform 16, Policy Engine Platform 18, Remote Access Platform 22, Action-Ability Platform 21 and/or Collaboration Platform 52 for the purpose of supporting the Supply Multi-Platform 55, and creating and sustaining the Crystalis “Business Periscope” Platform/s 46. See FIG. 2c (FIG. 2c).

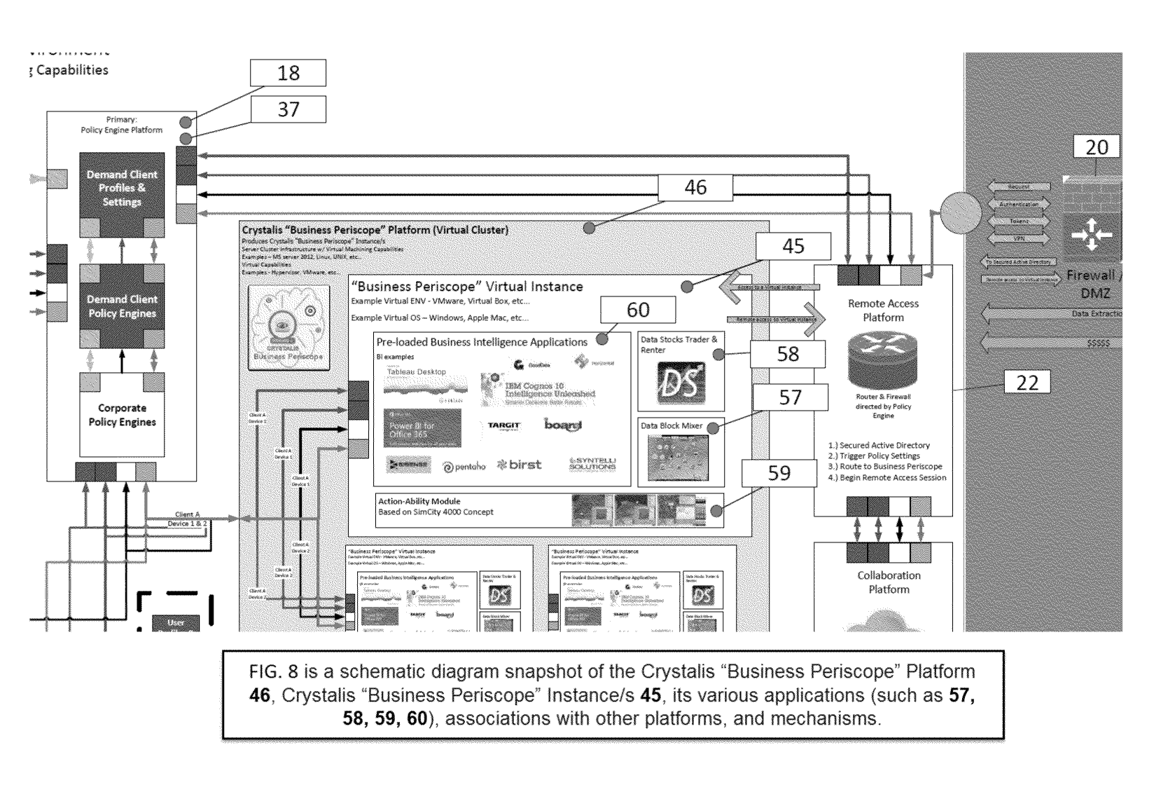

14. The platform of claim 13, wherein Crystalis “Business Periscope” Platform/s 46 can consist of server/s 5 and softwares that can create and sustain Crystalis “Business Periscope” Instance/s 45, which can be configured by the Policy Engines Platform 18. The platform can be created and sustained by a combinations of platforms, such as the Data Mixing Platform 14, Data Trading Platform 13, Data Renting Platform 15, Data Analytics/Business Intelligence Platform 16, Policy Engine Platform 18, Remote Access Platform 22, Collaboration Platform 52, and/or Action-Ability Platform 21. See FIG. 2c (FIG. 2c) and FIG. 8 (FIG. 8).

15. The platform of claim 14, wherein Crystalis “Business Periscope” Instance/s 45 can consist of remote desktop instance/s produced in Crystalis “Business Periscope” Platform/s 46, where a demand client user/s can view, mix, rent, produce Business “Deals” 26, trade, perform Secondary Data Market Activities 49, and/or act upon the Data Compositions 47, Aggregate Categorical Data Blocks 44, and/or sources of data. The instance/s can consist of several Desktop Applications 3 of Business Intelligence Applications 60, Data Stocks Trader & Renter Applications 58, Data Block Mixer Application 57, Action-Ability Module 59, and/or other support element that can be configured by the Policy Engines Platform 18. These instances can be accessed remotely via the Remote Access Platform 22 and collaborated upon by demand client/s team/s 52. In addition, when Crystalis “Business Periscope” Platform/s 46 are disconnected from the Data Stock Markets 42, Crystalis “Business Periscope” Instance/s can be used by demand client/s in the demand client/s's premise and/or private network. See FIG. 2c (FIG. 2c) and FIG. 8 (FIG. 8).

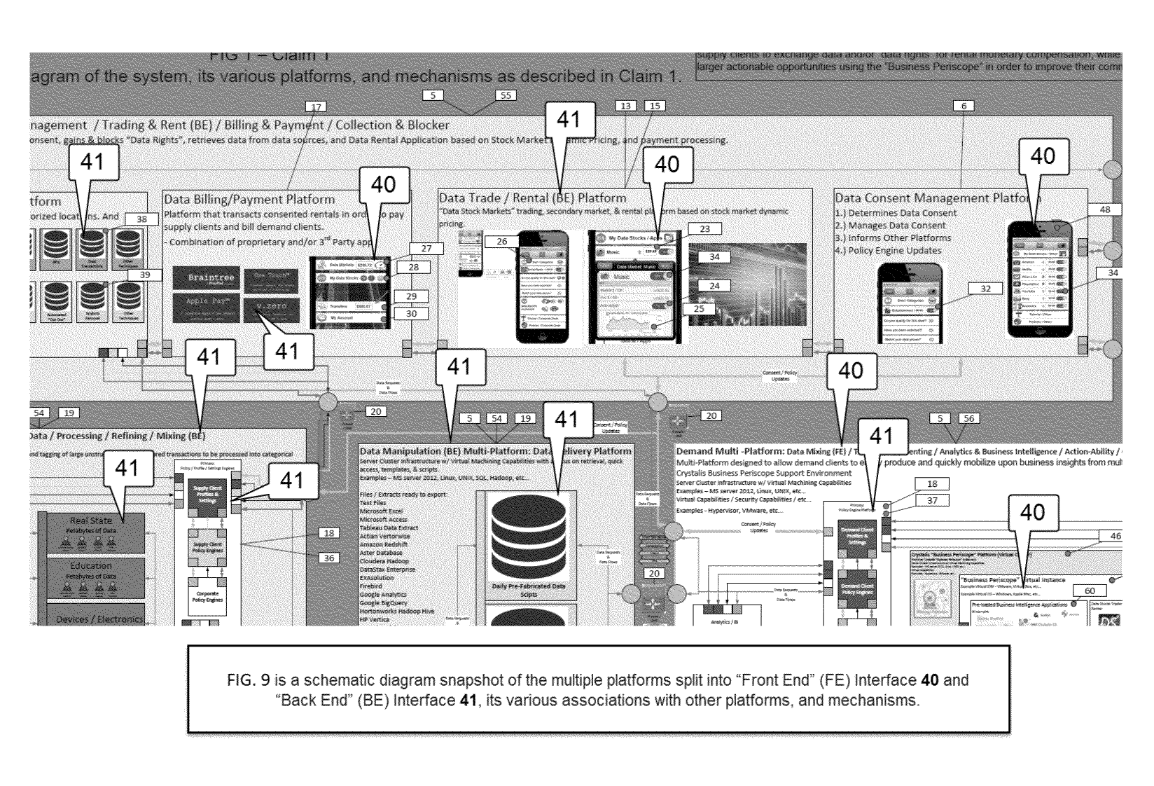

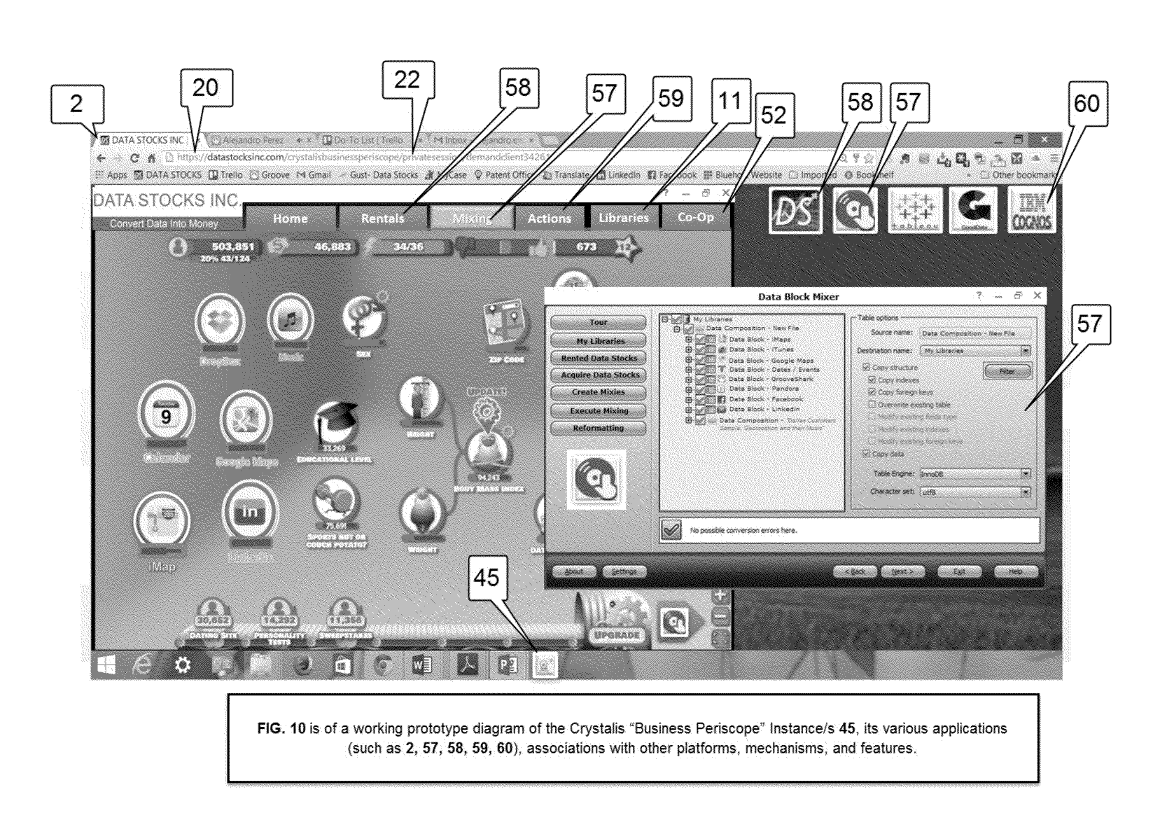

16. The system of claim 1, further the platforms can be split and segmented were the “Front End” Interface 18 (henceforth, abbreviated FE) and the “Back End” Interface (henceforth, abbreviated BE) can be utilized by different stakeholders; thus, the interfaces and locations of the platform/s may be inhabited in different physical locations, virtual locations, 3rd Parties, and/or outsourced in this unified system. And at times, repeated in order to segregate different clients for various reasons, to include security purposes, such as the Crystalis “Business Periscope” instance/s 45 and Crystalis “Business Periscope” Platform/s 46. See FIG. 9 (FIG. 9)
